(19) United States
(12) Patent Application Publication
(10) Pub. No.: US 2011/0071875 A1
(43) Pub. Date: Mar. 24, 2011

(54) SYSTEM AND METHOD FOR PERFORMING OILFIELD OPERATIONS

(76) Inventors: Morten Stenhaug, Sandsli (NO); Ali Razouki, Paris (FR)

(21) Appl. No.: 12/725,570

(22) Filed: Mar. 17, 2010

Related U.S. Application Data
(60) Provisional application No. 61/161,164, filed on Mar. 18, 2009.

(51) Int. Cl. G06Q 10/00

(52) U.S. Cl. 705/7.36

(57) ABSTRACT

A system and method for executing an oilfield operation at a wellsite is provided. The system comprises a project execution unit, an employee assessment unit and a matrix execution unit. The project execution unit is configured to quantify a plurality of project parameters for executed projects, wherein a first project parameter is a success rate of the executed projects, and a second project parameter is a required project team member competency for the executed projects. The employee assessment unit is configured to assess a level of expertise obtained by each of the employees for a plurality of skill sets. The matrix execution unit is configured to compare to the required project team member competency to the level of expertise of each of the employees in each of the plurality of skill sets in order to select a group of employees to be used to complete the project team.

### CROSS-REFERENCE TO RELATED APPLICATION

The present application is based on and claims the benefit of priority from U.S. Provisional Patent Application Ser. No. 61/161,164, filed by Applicant on Mar. 18, 2009; the entire contents of which are hereby incorporated by reference.

### TECHNICAL FIELD

The present disclosure generally relates to techniques for managing business operations, and more particularly to techniques for performing oilfield operations.

### DISCUSSION OF THE BACKGROUND

Oilfield operations are typically performed to locate and gather valuable downhole fluids. Typical oilfield operations may include various tasks, such as surveying, drilling, wireline testing, completions, production, planning, and oilfield analysis. Such oilfield operations are very complex and require skilled personnel to be deployed to various wellsites throughout the world to perform the necessary tasks. Getting the right people to the right wellsite to perform the needed task at a given time requires an understanding of the available personnel, constant updates and coordination.

In recent years, techniques have been used developed to allocate and deploy personnel as described, for example in U.S. Patent Application No. 2006/0294140. Despite the existence of techniques for managing information for a given project, it is desirable that such techniques take into consideration a knowledge management system to streamline project tasks in order to manage personnel, execute the project from sales to delivery and share knowledge and manage all suitable facets of a project. Such techniques are preferably capable of one or more of the following, among others: evaluating employee expertise, evaluating employee skill set, evaluating employee career path, evaluating employee training in accordance with expertise, determining skill sets and career paths, constructing project team positions, determining minimum expertise and skill set for employees filling project team positions, quantifying project parameters, quantifying project parameters in successful projects, using historical project data to compile proposals and marketing materials.

### SUMMARY OF THE DISCLOSURE

The present invention relates to a system for executing an oilfield operation at a wellsite. The oilfield operation is a potential project. The system comprises a project execution unit, an employee assessment unit and a matrix execution unit. The project execution unit configured to quantify a plurality of project parameters of at least one executed project, wherein a first project parameter is a success rate of the at least one executed projects, and a second project parameter is a required project team member competency for the at least one executed projects. The employee assessment unit configured to assess a level of expertise obtained by each of a plurality of employees for a plurality of skill sets. The matrix execution unit configured to compare to the required project team member competency to the level of expertise of each of the plurality of employees in each of the plurality of skill sets in order to select a group of employees to be used to complete the project team.

The present invention relates to a method for executing an oilfield operation at a wellsite. The oilfield operation is a potential project. The method comprises receiving a request for proposal and imputing the request for proposal into a framework of service unit, the framework of services unit. The framework of services unit comprises a project execution unit, an employee assessment unit and a matrix execution unit. The project execution unit is configured to quantify a plurality of project parameters of at least one executed project, wherein a first project parameter is a success rate of the at least one executed projects, and a second project parameter is a required project team member competency for the at least one executed projects. The employee assessment unit is configured to assess a level of expertise obtained by each of a plurality of employees for a plurality of skill sets. The matrix execution unit configured to compare to the required project team member competency to the level of expertise of each of the plurality of employees in each of the plurality of skill sets in order to select a group of employees to be used to complete the project team. The method further comprises comparing the request for proposal with the plurality of project parameters for the at least one executed projects. The method comprises compiling a proposed project execution plan based on the compared request for proposal. The method comprises assembling a bid proposal comprising the proposed project execution plan.

A method for optimizing a potential project for extracting hydrocarbons from an underground reservoir. The method comprises receiving a request for proposal. The method comprises imputing the request for proposal into a framework of service unit. The framework of services unit comprises a project execution unit, an employee assessment unit and a matrix execution unit. The project execution unit is configured to quantify a plurality of project parameters of at least one executed project, wherein a first project parameter is a success rate of the at least one executed projects, and a second project parameter is a required project team member competency for the at least one executed projects. The employee assessment unit configured to assess a level of expertise obtained by each of a plurality of employees for a plurality of skill sets. The matrix execution unit configured to compare to the required project team member competency to the level of expertise of each of the plurality of employees in each of the plurality of skill sets in order to select a group of employees to be used to complete the project team. The method comprises comparing the request for proposal with the plurality of parameters for the at least one executed projects. The method comprises optimizing the project team by matching the required project team member competency with a group of available employees having a required expertise. The method comprises commencing the project with the optimized project team. The method comprises constructing a drilling rig and advancing a drilling tool into the earth. The method comprises extracting hydrocarbons from the underground reservoir.

These together with other aspects, features, and advantages of the present disclosure, along with the various features of novelty, which characterize the invention, are pointed out with particularity in the claims annexed to and forming a part of this disclosure. The above aspects and advantages are neither exhaustive nor individually or jointly critical to the spirit or practice of the disclosure. Other aspects, features, and advantages of the present disclosure will become readily apparent to those skilled in the art from the following description of exemplary embodiments in combination with the accompanying drawings. Accordingly, the drawings and description are to be regarded as illustrative in nature, and not restrictive.

### BRIEF DESCRIPTION OF THE DRAWINGS

The present embodiments may be better understood, and numerous objects, features, and advantages made apparent to those skilled in the art by referencing the accompanying drawings. These drawings are used to illustrate only typical embodiments of this invention, and are not to be considered limiting of its scope, for the invention may admit to other equally effective embodiments. The figures are not necessarily to scale and certain features and certain views of the figures may be shown exaggerated in scale or in schematic in the interest of clarity and conciseness.

FIG. 1 is a schematic diagram depicting a system for executing one or more projects.

FIG. 2 is a schematic diagram depicting a system for executing one or more projects.

FIG. 3 is a block diagram illustrating a framework of services unit.

FIG. 4 is a screen shot illustrating an exemplary framework of services (FOS).

FIG. 5 is a screen shot illustrates the exemplary FOS of FIG. 4 marked with company provided services.

FIG. 6 is a screen shot illustrating an exemplary employee self-assessment form.

FIG. 7A is a screen shot illustrating an exemplary project score against the exemplary FOS of FIG. 4.

FIG. 7B is a schematic view of screen shots illustrating an exemplary process for providing group competency.

FIG. 7C is a screen shot illustrating an exemplary process for providing team competency.

FIG. 7D is a flowchart illustrating a process for providing a project team competency.

FIGS. 8A-8C are screen shots illustrating an exemplary knowledge management system for implementing the embodiments of FIGS. 4-7 and 9 the knowledge management system may be included in the framework of service unit of FIG. 3.

FIG. 9 is a screen shot illustrating an exemplary summary sheet for a case study entry.

FIGS. 10-19 are a screen shots illustrating of an exemplary web site corresponding to the knowledge management system of FIGS. 8A-8C.

FIG. 20 depicts a flowchart illustrating a method of performing an oilfield operation using the framework of services unit.

### DETAILED DESCRIPTION

The description that follows includes exemplary apparatus, methods, techniques, and instruction sequences that embody techniques of the present inventive subject matter. However, it is understood that the described embodiments may be practiced without these specific details.

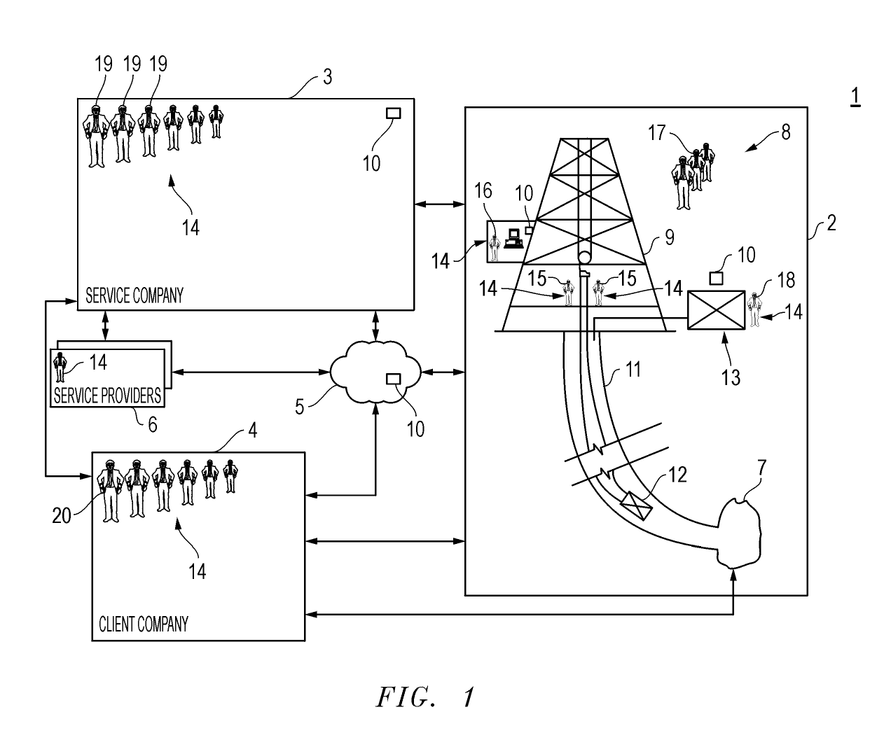

FIG. 1 depicts a schematic view of a system 1 for executing one or more projects 2. The system may include a service company 3 for executing the one or more projects 2 for a client company 4. One or more secondary service providers 6 may be used in addition to the service company 3 in order to execute the project 2, or portions of the project 2. A communication network 5 may be used to communicate between the project 2, the service company 3, the client company 4 and/or the secondary service providers 6. The system 1 may include a framework of services unit 10 configured to manage and enhance one or more project functionalities and thereby increasing the effectiveness and repeatability of the project 2, as will be discussed in more detail below.

The execution of capital projects may require a variety of resources. Most capital projects require resources such as personnel, knowledge, communication systems between entities working on the project, time management, cost management, training of personnel, and the like. For a capital project to be successful there may be one or more project parameters that must be met, such as schedule and budget. To repeat the success of capital projects on a consistent basis certain project functionalities, for example proper personnel, may be quantified, measured, analyzed, compared, and contrasted. The quantified repeatability of the successful capital project may increase the ability of the service company 3 to estimate and bid for future capital projects from the one or more client companies 4.

The capital project, or the project 2, may be any project that the client corporation 4 wants to execute in order to further their business. As shown, the project 2 is an oil services project for recovering one or more hydrocarbons from a subsurface reservoir 7 at a wellsite 8. An oil rig(s) 9 may be installed and positioned at the wellsite(s) 8 for performing a variety of oilfield operations, such as drilling a wellbore, performing downhole testing and producing located hydrocarbons. One or more drilling tools 12 may be advanced into the earth from the rig 9 to form a wellbore 11. Drilling muds are often pumped, from a fluid control system 13, into the wellbore 11 as the drilling tool 12 advances into the earth. The drilling muds may be used, for example, to remove cuttings, to cool a drill bit at the end of the drilling tool and/or to provide a protective lining along a wall of the wellbore. During or after drilling, casing is typically cemented into place to line at least a portion of the wellbore 11. Once the wellbore 11 is formed, production tools may be positioned about the wellbore 11 to draw fluids, and/or hydrocarbons, to the surface. The client company 4 may own the rights to sell and distribute the hydrocarbons. The service company 3 may supply the equipment, project personnel, subcontracts with secondary service providers, knowledge, communication networks (or communication plans) to successfully execute the project from start-up to completion.

The oil services project may require the management and use of a plurality of project personnel 14. The project personnel 14 may provide any suitable service to the project 2 including, but not limited to, installing and decommission the equipment, collecting quantify and analyze data collected both from the wellsite 8 and offsite, operating the tools and systems about the wellsite 8, providing schedules, providing budgets, providing cost estimates, projecting economic analysis, projecting risk analysis, providing contracting strategies, identifying resources to be used, identifying and providing project personnel, defining the scope of work, determining project execution strategies, and implementing the project execution strategies and the like. The project personnel 14 may be required at any of the locations about the system 1, for example, at the wellsite 8, within one or more offices of the service company 3 and at the client company 4. The project personnel for the oil services project may require one or more specific project positions to be filled by employees of the service company 3, the secondary service provider company 6, and/or the client company 4. For example, the specific project positions may include, but is not limited to, one or more laborers 15, one or more field engineers 16, one or more project managers 17 (or project services employees), one or more reservoir managers 18, one or more office staff members 19, and the like.

For the oil service project, or the project 2, to be successful, a minimum level of expertise and/or training for each of the specific project positions may be required. The expertise for each of the specific project positions may be determined and compared to the service companies employee pool in order to maximize the success rate of the projects 2, as will be discussed in more detail below. The framework of services unit 10 may optimize the use of the project personnel 14 by optimizing one or more of the project functionalities such as the employee assessment, training and career planning, and the like. In addition to the project personnel, the project equipment used for the project 2 may be optimized using the framework of services unit 10.

During the life of the project 2 various project parameters, for example cost, schedule, budget, safety and the like, may be determined, categorized, measured and analyzed. The project parameters may be optimized by the framework of services unit 10 in order to optimize and/or effect one or more of the project functionalities. For example, project execution and/or marketing may be optimized using the framework of services unit 10, as will be discussed in more detail below.

Although the project 2 is described as an oil services project, it should be appreciated that the system 1 using the framework of services unit 10 may be used to optimize any project, and/or capital project, including, but not limited to, upstream oil projects, downstream oil projects, chemical plant projects, construction projects, municipal projects, and the like.

The service company 3, as shown, is an oilfield services company. The oilfield services company may provide a full range of oilfield services including, but not limited to, exploration, drilling, completions, recovery, distribution, communication, interface management, reservoir monitoring and optimization, project management services and the like. The oilfield services company may have multiple offices, field offices, and field crews located worldwide. Although, the service company 3 is described as being an oilfield services company, it should be appreciated that the service company 3 may be any suitable company for executing the project 2 for the client 4 including, but not limited to, an ENC company, a construction company, an engineering company, an oil company, and the like. The one or more secondary service providers 6 may be any suitable service provider for assisting the service company 3 and/or the client company 4 in the execution of the project 2. The client company 4 as shown is an oil company. However, it should be appreciated that the client company 4 may be any company requiring a project to be executed, for example, a chemical company, a government entity, a retailer, and the like. Although the service company 3, the secondary service provider 6 and the client company 4 are described as three separate entities, it should be appreciated that they could all be the same entity working on the successful execution of the project 2.

The communication network 5 for communicating about the system 1 may be any suitable communication plan(s), workflow(s), and/or communication network(s) for transferring information and/or knowledge. The communication network 5 may use any combination of communication devices, systems or methods including, but not limited to, mail, document control departments, telephones, telephone conferences, email, face to face meetings, wireless, fiber optics, acoustic, infrared, through the internet using an internet service provider, a local area network (LAN), a personal area network (PAN), and/or a wide area network (WAN). The framework of services unit 10 may be located partially or wholly within a portion of the communication network 5.

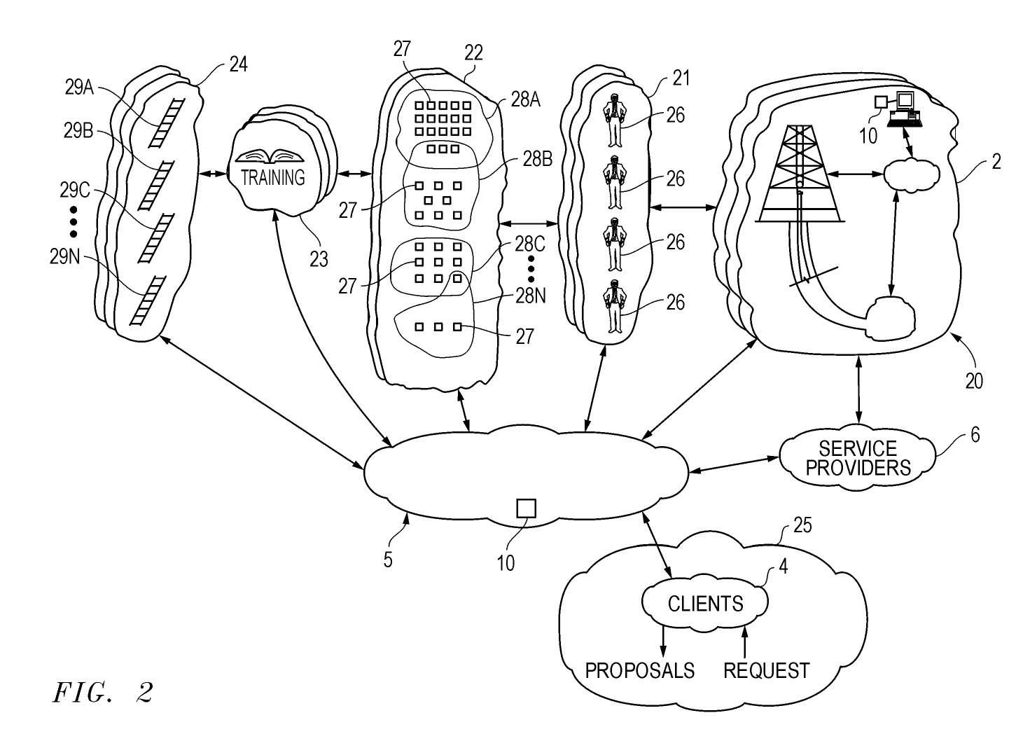

FIG. 2 shows the system 1 for executing the project 2 depicting a plurality of project functionalities for optimizing project execution. The project functionalities may be any project parameter, combination of project parameters, project function and/or combination of project functions that may be measured, quantified, analyzed and/or improved in order to successfully execute and market the projects 2. As shown, the project functionalities comprise project execution and analysis 20, the project team 21, an employee pool 22, employee training 23, career development 24, and marketing and sales 25. The framework of service unit 10 may streamline these project functionalities in order to efficiently manage personnel, execute the projects 2 from sales to delivery and share knowledge obtained from the projects 2. The project functionalities as optimized are not limited to those shown in FIG. 2. For example, the project functionalities may include any suitable quantifiable project parameter and/or functionality including, but not limited to, equipment used, location of project, location of employees, and the like.

The project execution and analysis 20 functionality may be a combination of project parameters that may effect, and/or value, the project. For example, the project execution may be effected by a number of project parameters, such as the project team assembled, the equipment used, the location of the project, the government entities regulating the project, weather at the jobsite, and the like. Each of these project parameters may be quantified using the framework of services unit 10. Further, the executed and/or completed project may be scored and/or measured in order to determine the likelihood of success on future projects by the framework of services unit 10, as will be discussed in more detail below.

The project team 21 may represent a combination of one or more specific project personnel positions 26 that may be filled in order to effectively execute the project 2. Each of the specific project personnel positions 26 may represent any number of jobs for project execution. The specific personnel positions 26 may range in skills. For example, the skill sets may comprise a sales person, a laborer, an executive, an engineer among others. Each of the one or more specific project personnel positions 26 may be quantified and filled using the framework of services unit 10.

The employee pool 22 may comprise of a plurality of employees 27 who work for or with the service company 3 (as shown in FIG. 1). The employees 27 may be used to fill each of the one or more specific project personnel positions 26 for the project team. Each of the employees may have varying skill sets 28A-N. The skill sets 28A-N of the employees may be based on a variety of parameters including, but not limited to, training, education, and/or experience. Each of the skill sets 28A-N may represent one or more of the skills required for the specific project personnel positions 26 of the one or more projects 2. Within each of the skill sets 28A-N, the employee may achieve a variant degree of expertise. For example, an entry level employee for a skill set 28A, for example, may have a low level of expertise; whereas, an experienced employee for the skill set 28A may have a high level of expertise. The separate skill sets 28A-N may represent skills for any number of the specific project personnel positions 26 that need to be filled for the project team 21. As an example, skill set 28A may be the skill set required for a laborer. Skill set 28B may be the skill set required for a project services person (for example a cost controller or scheduler). The skill set 28C may be the skill set required for an engineer. The skill set 28N may be the skill set required for a project manager, a sales person and/or an executive. Some employees 27 may be able to perform multiple skill sets 28A-N as their level of expertise and/or training increases. For example, as a laborer increases their level of expertise they may eventually be able to take on the tasks of some of the next skill set level, for example project services personnel.

The employees 27 level of expertise may be determined by any suitable method. In one example, the employee may complete a self assessment of their skills. The self assessment of the employees skills may be completed at any time, or at a scheduled time for the employee. For example, each employee may be required to perform a self assessment upon starting a new position at the company. Further, the self assessment may be required at certain time intervals, for example monthly, yearly, bi-annually, every five years and the like. Further, the self assessment may be required after milestones have been reached, for example the completion of a project, the completion of a training course, and the like. Although, the level of expertise for the employee is described as being determined by a self assessment, the level of expertise may be determined by peers, superiors, employees and a combination thereof. Further, the level of expertise for the employee may be updated automatically upon the completion of one or more of the milestones. The framework of services unit 10 may categorize each of the employees according to their skill set 28A-N and there level of expertise within the skill set 28A-N, and/or in another skill set.

The employee training 23 functionality may comprise one or more training courses and/or on the job experiences that the employee may engage in to obtain more skill and/or expertise. The skill and expertise obtained in the employee training 23 may apply directly to the employee's 27 skill set 28A-N they are employed for, or may apply to a different skill set 28A-N. The employee training 23 may increase the employee's 27 expertise in the applicable skill set 28A-N. The effectiveness of the employee training 23 may vary depending on the a variety of training parameters. For example, working in the field on a project for a year may greatly increase the employee's 27 expertise in a variety skill sets 28A-N, where taking a two hour course on the project may only increase the employee's 27 expertise marginally. Therefore, the employee training 23 may be ranked, scored and/or weighted according to their effectiveness for increasing expertise in the skill sets 28A-N. The framework of service unit 10 may use the ranked, or scored, employee training 23 in order to increase the effectiveness of the service companies workforce while at the same time assisting in the execution of the projects 2.

The career development 24 functionality may comprise one or more career paths 29A-N that the employee 27 may embark on, or aspire to, over the course of their employment. The career path may be chosen by the employee, one or more peers, and/or one or more superiors during the course of the employee's 27 time with the service company. The career paths 29A-N may range, for example, from being a laborer for an entire career to becoming the CEO of the service company. Certain goals, or qualifications, such as increased expertise in the skill sets 28A-28N, may be determined and achieved by the employee 27 in order to move along the career path 29A-N chosen for the employee 27. The framework of services unit 10 may use the career path 29A-N in order to determine future assignments and/or training for the employees 27.

The marketing and sales 25 functionality may comprise one or more sales tactics, methods, and/or applications that may be used to secure business now and in the future. The marketing and sales 25 tactics employed by various sales teams, or individuals may be graded on successfulness. Further, the framework of services unit 10 may use data and/or information obtained by all, or a portion of, the project functionalities as a sales tactic. For example, the framework of services unit 10 may customize a project execution plan for the client based on past projects and information obtained by any of the project functionalities as will be described in more detail below.

The framework of service unit 10 may collect, obtain, categorize, compare, contrast and manipulate data, and/or information, from all of the project functionalities. The data collected may be used by the service company 3, the client company 4, the service providers 6, the employees 27 (as shown in FIGS. 1-2) and/or a combination thereof in order to effectively execute the projects 2. The framework of service unit 10 may employ a framework of services matrix, or matrix, or FOS, in order to optimize project execution, success and repeatability. The framework of service matrix may pull data from the system 1, and/or the various project functionalities in order to optimize project execution, project repeatability and/or project sales. The project of services matrix may use a scaled system for each of the project functionalities. The scaled system may be any suitable scaled system so long as it can be standardized between the project functionalities for use by the framework of services matrix. In one example, the scaled system may be a numbering system. In another example, the scaled system may be a color coded system. In another example, the scaled system may be an alphabetical system. In another example, the scaled system may be an alphanumeric system. Further, the scaled system may be any combination of systems described herein. For example, the scaled system used by the framework of services matrix may be based on a numbering system from 0 to 4. The 0 may represent no value, awareness, experience, etc. for each of the project functionalities. The 1 may represent a minimum level of value, awareness, experience, for each of the project functionalities. The 2 may represent an effective medium value, awareness, experience for example skilled in experience for each of the functionalities. The 3 may represent an advanced level of value, awareness, experience for each of the functionalities. The 4 may represent an expert level of value, awareness, experience for each of the project functionalities.

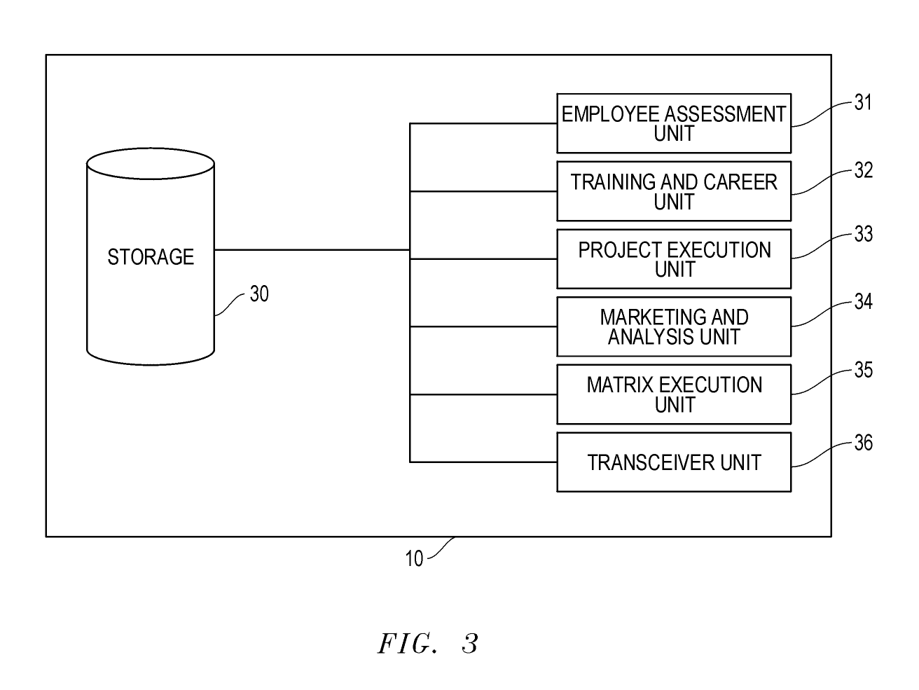

FIG. 3 depicts a diagram illustrating a framework of services unit 10. The framework of service unit 10 may include a storage device 30, an employee assessment unit 31, a training and career unit 32, a project execution unit 33, a marketing and analysis unit 34, a matrix execution unit 35 and a transceiver unit 36. Part or all of the framework of service unit 400 may be positioned about the system 1 (shown in FIG. 1) and/or at one or more computers used by the employees 27 (shown in FIG. 2). The framework of services unit 10 may be in communication with the communication networks 5. There may be multiple framework of services units 10 that any number of people, and/or employees 27 may access. Further, the framework of service unit 10 may be located within the communication network 5 and accessed by multiple people and/or employees 27.

The storage device 30 may be any conventional database or other storage device capable of storing data associated with the system 1 (as shown in FIG. 1). Such data may comprise, for example, historical data, employee inputs, peer input, superior input, data regarding project functionalities, project execution data, and the like. The transceiver unit 36 may be any conventional communication device capable of passing signals (e.g., power, communication) to and from and within the framework of service unit 10.

The employee assessment unit 31 may assess each of the employee's 27 expertise levels within one or more of the skill sets 28A-N. The employee 27 may fill out a self assessment form. The self assessment form may be collected, stored, and manipulated by the employee assessment unit 31. Further, the employee 27 may have any number of assessments completed by peers and/or superiors collected, stored and manipulated by the employee assessment unit 31. These assessments of the employee's 27 expertise may be collected for employees located at all of the service companies 3 locations worldwide. Therefore, the employee assessment unit 31 may contain assessments of the entire workforce, or portions thereof, for the service company 3. Any one of these assessments and/or a combination of the assessments may be used by framework of services unit 10 for the framework of services matrix.

The assessment of the employee's 27 expertise in the skill sets 28A-N may have any suitable form that may be standardized by the framework of services matrix. For example, the assessment may be scaled for each of the expertise level in each of the employee's 27 skill sets. For example, the employee's level of expertise in drilling equipment may be scaled, as well as the employee's level of expertise in scheduling. The scaled system may be any of the scaled systems for standardizing the skill sets 28A-N described herein. For example, the scaled system may be a numbering system between the numbers of 0 and 4, wherein 0 represents no expertise and 4 represents the highest level of expertise.

The training and career unit 32 may assess each of the training 23 programs available to the employees 27. The training 23 may be assessed by the people who have completed the training, the administrators of the training, the teachers of the classes, the bosses, or anyone who is involved with the training 23. The assessments of the training 23 may be collected for the training 23 completed at all of the service companies 3 locations worldwide. Therefore, the training and career unit 32 may contain assessments of the entire training program, or portions thereof, for the service company 3. Further, the training and career unit 32 may assess and guide each of the career paths 29A-N. The assessment of the career paths 29A-N may comprise determining scaled levels of training and expertise required to move along the chosen career path 29A-N. Therefore, each of the career paths 29A-N may be determined and/or scaled by the training, experience and/or expertise an employee has obtained. Any one of these training and/or career assessments and/or a combination of the assessments may be used by the framework of services unit 10 for the framework of services matrix.

The assessment of the training 23 and/or the career paths 29A-N may have any suitable form that may be standardized by the framework of services matrix. For example, the assessment may be scaled for each of the training and/or the career paths 29A-N for each of the training courses, and each move up the ladder within each of the career paths 29A-N. The scaled system may be any of the scaled systems for standardizing the training 23 and/or the career paths 29A-N described herein. For example, the scaled system may be a numbering system between the numbers of 0 and 4, wherein 0 represents no training and/or no career benefit and 4 represents the highest level of training and/or the highest level of career benefit.

The project execution unit 33 may assess various project parameters in order to optimize project execution and/or project repeatability. The project parameters that may be assessed may include, but are not limited to, the project team 21, the client satisfaction, the cost, the schedule, the equipment used, engineering methods used, the budget, the best practices and the like. Each of these project parameters may be quantified using the scaled system. The project parameters may be quantified by the any of the project team members, the client, empirical data and the like. The quantified project parameters may be collected, stored, and manipulated by the project execution unit 33. These quantified project parameters may be collected for each project performed at the service companies 3 locations worldwide. Therefore, the project execution unit 33 may contain quantified project parameters, and historical project parameters, of the entire service company's 3 project portfolio. Further, the project execution unit 33 may quantify project success level as a project parameter. The successful projects may then be mirrored in order to optimize project execution and repeatability. Any one of these quantified project parameters and/or a combination of the project parameters may be used by the framework of services unit 10 for the framework of services matrix.

The quantified project parameters may have any suitable form that may be standardized by the framework of services matrix. For example, the quantified project parameter may be project success. The scaled system may be any of the scaled systems for standardizing the framework of services matrix as described herein. For example, the scaled system may be a numbering system between the numbers of 0 and 4, wherein 0 represents no success and 4 represents the highest level of success for the project.

The marketing and analysis unit 34 may assess various marketing and/or sales techniques. The marketing and/or sales techniques may include successful bid rate, repeat business after projects, market conditions, government involvement, and the like. Further, the marketing and analysis unit 34 may assess upcoming projects based on there multiple project parameters in order to customize a bid and/or proposal for the client. The various marketing and/or sales techniques may be quantified according to success rate using the scaled system. The quantified marketing and/or sales techniques may be collected, stored, and manipulated by the marketing and analysis unit 34. These quantified techniques may be collected for each project bid for by the service companies 3 locations worldwide. Therefore, the marketing and analysis unit 33 may contain quantified marketing and sales techniques, and historical marketing parameters, of the entire service company's 3 project portfolio. Any one of these quantified techniques and/or combination of techniques may be used by the framework of services unit 10 for the framework of services matrix.

The quantified marketing and/or sales techniques may have any suitable form that may be standardized by the framework of services matrix. The scaled system may be any of the scaled systems for standardizing the framework of services matrix as described herein. For example, the scaled system may be a numbering system between the numbers of 0 and 4, wherein 0 represents no success and 4 represents the highest level of success for the marketing team.

The matrix execution unit 35 may execute the functions of the framework of services matrix using the data from each of the employee assessment unit 31, the training and career unit 32, the project execution unit 33, and/or the marketing and analysis unit 34. Because the data in each of the project functionalities is standardized, the data regarding each of the project functionalities may be easily compared, manipulated, calculated, contrasted against each other by the framework of services matrix. The framework of services matrix may generate reports regarding multiple facets of the system 1.

As an example of a function of the framework of services matrix, the framework of services matrix may modify the scale of an employee's expertise in a skill set 28A-N automatically upon completion of the training 23. The framework of services matrix may then compare the level of expertise with the one or more career paths 29A-N chosen for the employee. If the level of expertise is sufficient to move the employee up the career ladder, the framework of service matrix may then move the employee to the next level in the career path 29A-N. The FOS matrix may then compare the employee's current career situation and/or expertise level with their intended career path. The new career path level for the employee may then be used for advancement of the employee's career through, for example, a raise, a promotion, a new position and/or a new assignment.

The FOS matrix may generate a report or notification to the employee regarding upcoming training 23 that may further the employee along a career path. Further, management may use one or more reports generated by the FOS matrix in order to staff vacancies at the company and/or move the employee to another position within the company. For example, the FOS matrix may determine an open position within the company. The FOS matrix may then compare the position with the career path 29A-N that fits the position. The FOS matrix may then search for employees who match the career path 29A-N for the position. The FOS matrix may further find employees who have the expertise required for the position. The FOS matrix may then supply management, and/or human resources (HR) with a list of candidates who would be most suited for the position based on their career path 29A-N and their expertise within the skill sets 28A-N.

In another example, the FOS matrix may determine and build the project team 21, as shown in FIG. 2. The FOS matrix may receive a request to build the project team 21 for a particular project. The FOS matrix may obtain data from past projects in order to determine which skill set and how many employees having each skill set, were required to complete the project team 21. The expertise of each of the employees required may also be determined based on the scaled project functionality. The number of skill sets and employees may be optimized by comparing what was done on several successful similar projects in the past. For example, the FOS matrix may determine that the project team requires one project manager who is an expert project manager, and ten laborers who have only a low level of experience. The FOS matrix may then populate the potential project team with suitable employees based on expertise, skill set, career path, training needed for the employee, current project status that the employee is on, location around the world and the like. A report may be generated providing the list of available employees. From the report, a decision maker, and/or the FOS matrix may assemble the project team 21 selected for the job.

In another example, the FOS matrix may prepare and market brochures and/or proposals. For example, the service company 3 may receive a request to bid on a potential project. The potential project may be input into the FOS matrix. The FOS matrix may then search the project execution unit 33 for historical data regarding similar projects. The FOS matrix may then evaluate the potential project and compare it with executed projects that were similar to the potential project. Once the FOS matrix has found one or more executed projects that have similar project parameters to the potential project, the FOS matrix may rank the executed projects based on the project success as scaled by the project execution unit 33. The FOS matrix may further evaluate the successful projects based on project parameters that are important to the client. Using the scaled comparisons of the executed projects, the FOS matrix may create a set of project parameters for the potential project that will be likely to be executed with success. For example, the FOS matrix may pick the project team members, the skill levels of the project team, the potential employees to staff the project team, the equipment used to execute the project and the like. The FOS matrix may then generate a report and/or proposal to the client outlining the project parameters for the potential project. All of the project parameters may be scaled according to the scaling method chosen for example the numeric scale between 0 and 4. Thus, within a short time of receiving a request for bid, or quote, a complete, in depth proposal may be created by the FOS matrix and sent to the client via the communication network 5.

Embodiments depicted in the framework of services unit 10 may take the form of an entirely hardware embodiment, an entirely software embodiment (including firmware, resident software, micro-code, etc.) or an embodiment combining software and hardware aspects. Embodiments may take the form of a computer program embodied in any medium having computer usable program code embodied in the medium. The embodiments may be provided as a computer program product, or software, that may include a machine-readable medium having stored thereon instructions, which may be used to program a computer system (or other electronic device(s)) to perform a process. A machine readable medium includes any mechanism for storing or transmitting information in a form (such as, software, processing application) readable by a machine (such as a computer). The machine-readable medium may include, but is not limited to, magnetic storage medium (e.g., floppy diskette); optical storage medium (e.g., CD-ROM); magneto-optical storage medium; read only memory (ROM); random access memory (RAM); erasable programmable memory (e.g., EPROM and EEPROM); flash memory; or other types of medium suitable for storing electronic instructions. Embodiments may further be embodied in an electrical, optical, acoustical or other form of propagated signal (e.g., carrier waves, infrared signals, digital signals, etc.), or wireline, wireless, or other communications medium. Further, it should be appreciated that the embodiments may take the form of hand calculations, or employee/personnel comparisons. To this end, the employees, or engineer(s) may receive, manipulate, catalog and store the data from the system 1 in order to perform task depicted in the framework of services unit 10. Additional specific applications, inputs and outputs of the framework of services are depicted below.

In operation, the framework of services (FOS) unit 10 may manipulate a framework of services matrix that contains the different services that will be offered by the business, service company 5, as shown in FIG. 1. The process of the framework of service unit 10 may be based on the mapping all the services that the business will provide against the framework of services matrix. The FOS unit 10 may be used score the employees expertise in each of the service areas in scale from 0 to 4 (0. None, 1.aware, 3.skilled, 4.advanced and 5.Expert), score the career profiles (for example 26 in total), score the training courses according to targeted levels of the FOS services (and/or project parameters), score best practice according to their relevance to the FOS services (and/or project parameters), score bids according to their relevance to the FOS services (and/or project parameters), score projects according to their relevance to the FOS services (and/or project parameters), score projects documents output according to their relevance to the FOS services (and/or project parameters), score knowledge items and best practices according to their relevance to the FOS services. The resulting output for the employees expertise may be the self-assessment form.

The framework of service unit 10 may manage competency and careers. Group (project team) competency can be determined. The FOS unit 10 may use of the self assessment form to track employee skills development. The FOS unit 10 may build any employee career roadmap starting from his current self-assessment score to the targeted career profile. The FOS unit 10 may select training program for the employee, the appropriate trainings will be easily identified using their score against the FOS.

The framework of service unit 10 may execute projects efficiently through the following: easy selection of the project teams that match the project skills requirements, efficient and targeted search of best practice that relate to either of many of the FOS services items, quick determination of the past projects which knowledge can be used for the current project.

The framework of services unit 10 may support marketing and sales activities. For example, the FOS unit 10 may create project bid packages that will be used to demonstrate to customers the business skills capabilities and projects experience in the service areas required by the customer bid document. By looking at projects and bids FOS's, the business will determine the area of focus of its future business offering. The project bid FOS will be used to select teams for the projects and reuse proposals from past similar projects.

The process can be based on the mapping of all or some of a range of services in a matrix called a framework of services (FOS) (the framework of services matrix). The FOS is used to score company employees' expertise in each of the service areas on a suitable scale (e.g., on a scale from 0 to 4), map career profiles, score best practices, score bids and score projects according to their relevance to the FOS services. Advantageously, the scoring mechanism may be used to enable the efficient execution of projects, including selecting the employee with the appropriate skills for a given project, searching for the best practice relevant to the project, retrieving past projects similar to the current project enabling the reuse of previously-developed knowledge, competency and career management, marketing and sales analysis, and the like. The process steps can be coded in any suitable knowledge management application, for example, based on MICROSOFT SHAREPOINT™.

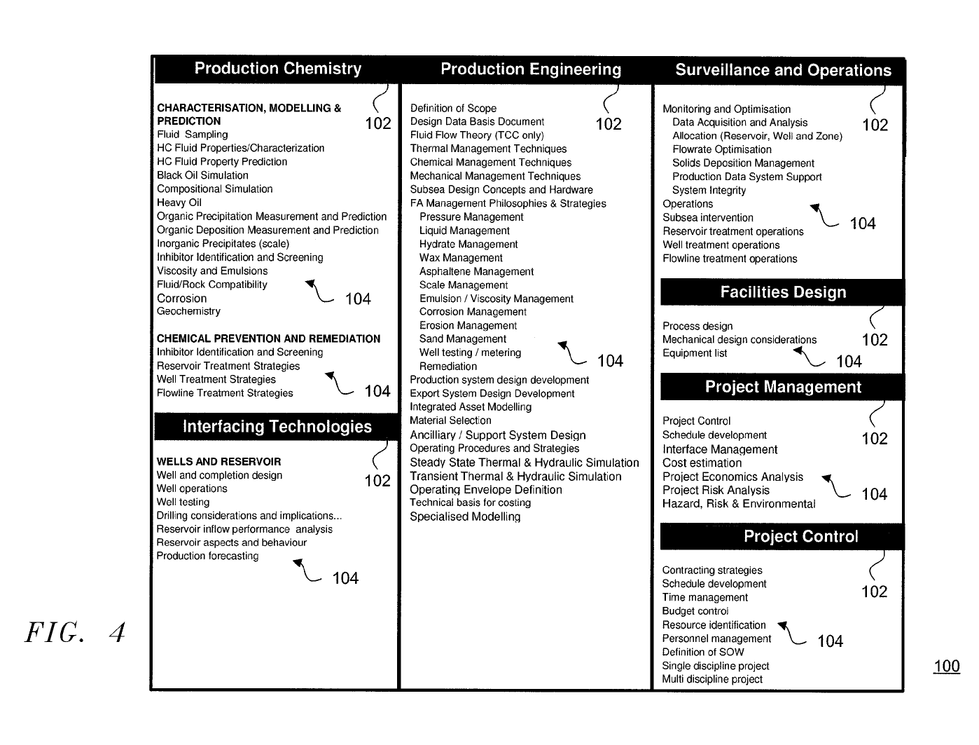

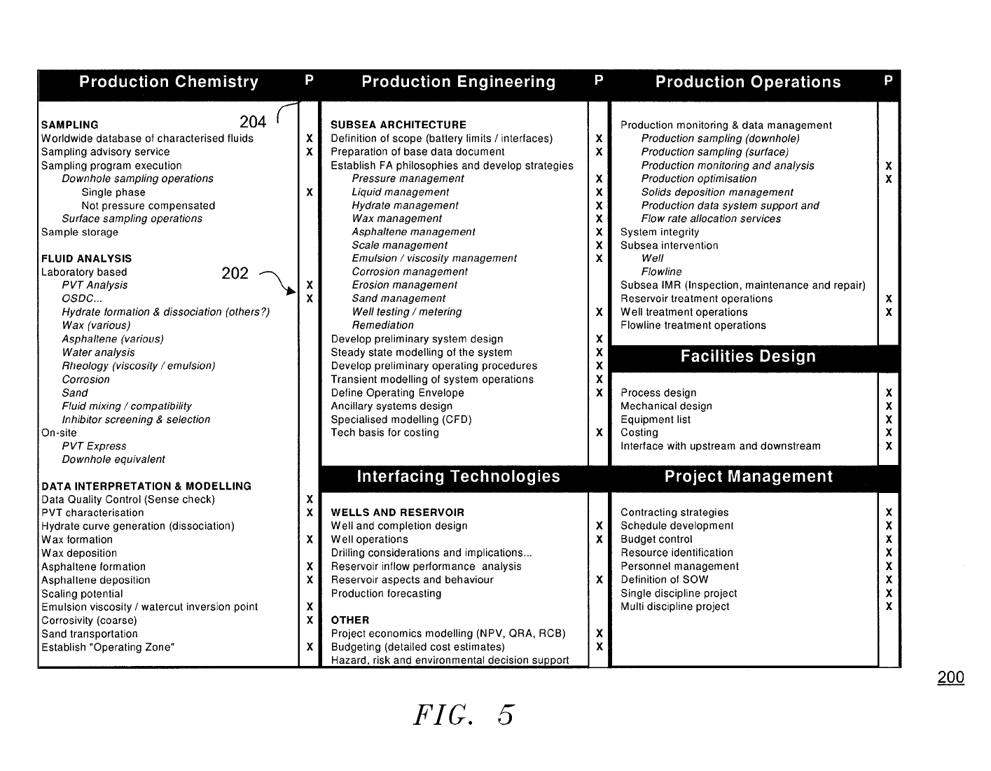

Referring now to FIGS. 4-19, wherein like reference numerals designate identical or corresponding parts throughout the several views, and more particularly to FIG. 4 thereof, there is illustrated a framework of services (FOS) 100. In FIG. 1, the FOS 100 is configured as matrix that includes the different services 102 and subservices 104 that will be offered by a company business. A mapping and scoring process can be employed, including the mapping of all of the services that the business will provide against the FOS. FIG. 5 illustrates the FOS 200 marked with an “x” at 202 with the services that the business will provide for a given project (P) 204.

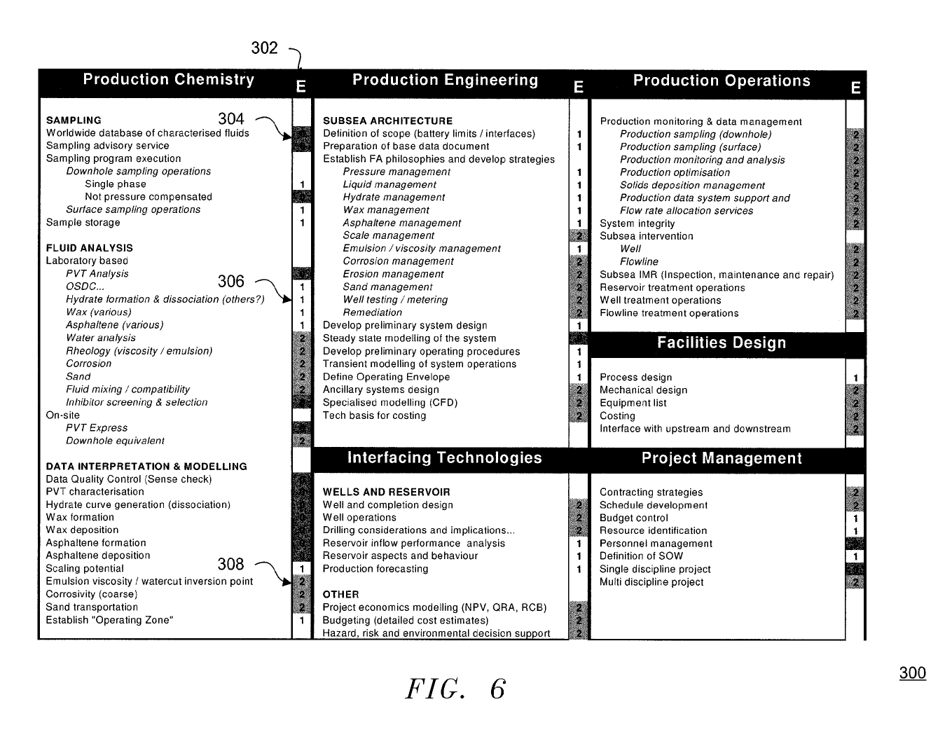

As shown in FIG. 6, the FOS is also used to score the expertise of an employee 302 in each of the service areas on a suitable scale, for example, on a scale from 0 to 4, where 0=none, 1=aware, 2=skilled, 3=advanced, and 4=expert), and wherein the 0 score can be shown in red 304, the 1 score can be shown in yellow 306, the 2 score can be shown in green 308, and so on. The resulting output comprises a self-assessment form 300. Accordingly, engineers can, in a systematic way, assess their skills and training needs and career paths. The form 300 shows the main technical areas and the profile is stored in the competency database together with other employee assessments. The competencies can then be combined to provide competency for any suitable organizational unit or level. Each item can also have identified training courses attached thereto, which each employee completed or will complete to clearly indicate the proper training level and to reduce the lead time for new engineers to reach an acceptable competency level. The training can include awareness of company products and services. This can also be used for recruiting candidates with the right profiles and to visualize candidate and area requirements. Consultants can use the form 300 to provide customers with the optimum solution.

In a similar manner, the FOS also can be used to score career profiles (e.g., 26 profiles in total), score training courses according to targeted levels of the FOS services, score best practices according to their relevance to the FOS services, score bids according to their relevance to the FOS services, score projects according to their relevance to the FOS services, score output of documents for projects according to their relevance to the FOS services, score knowledge items and best practices according to their relevance to the FOS services, and the like.

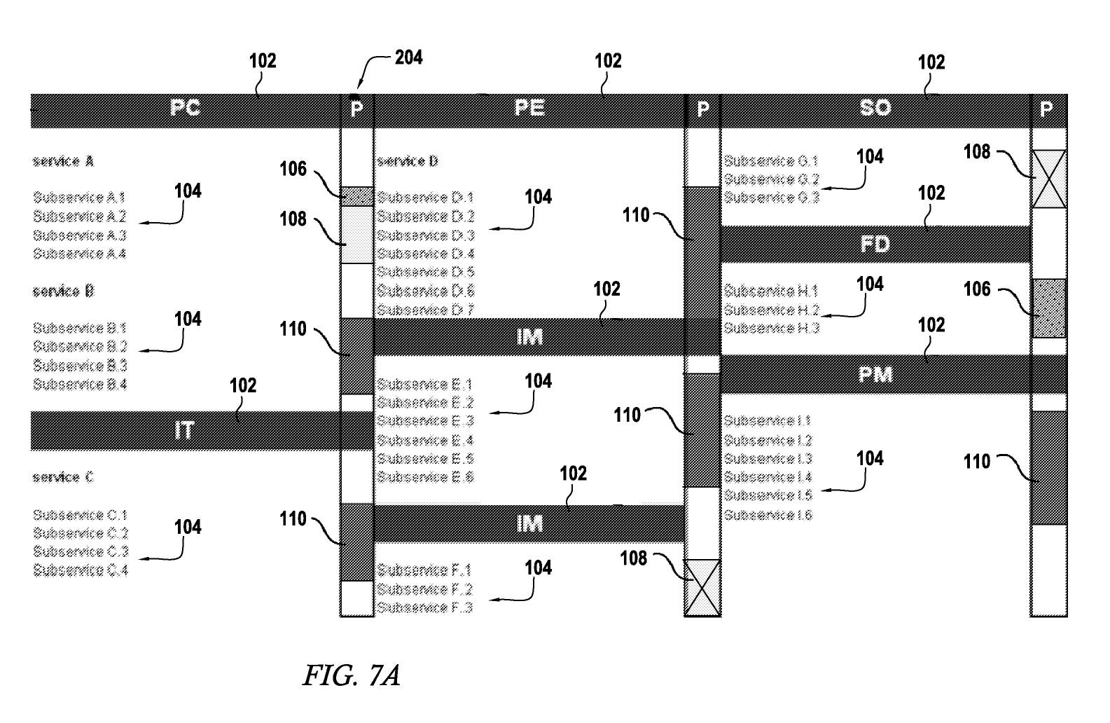

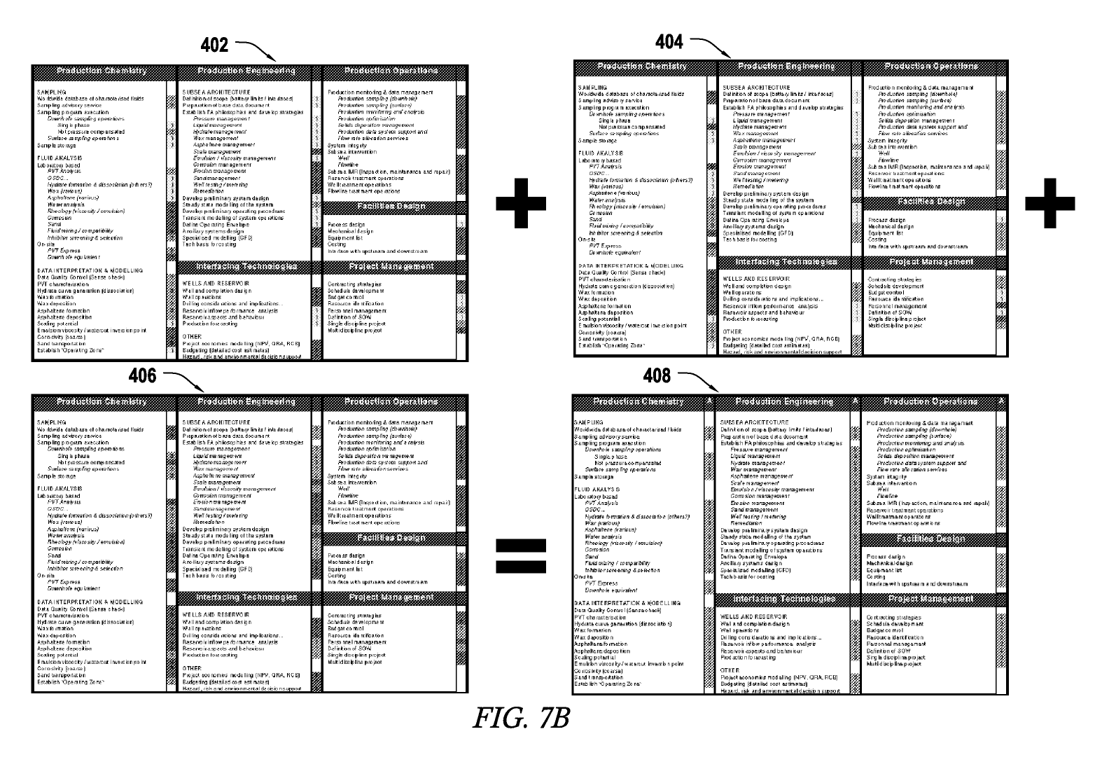

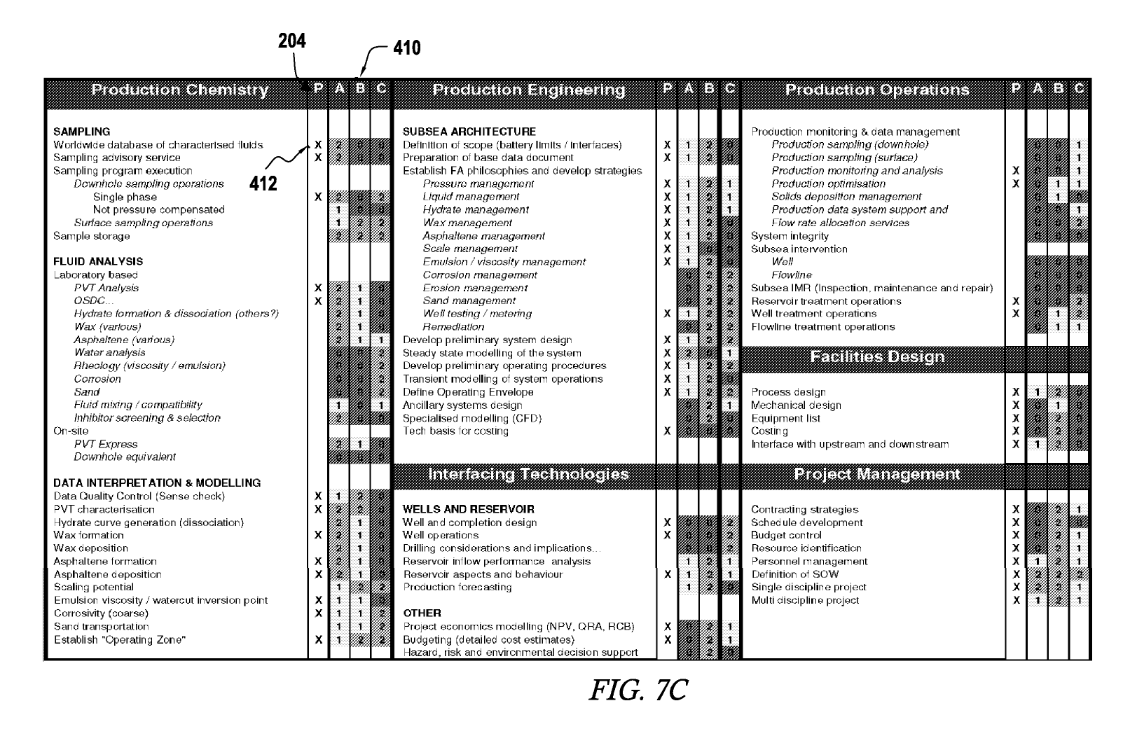

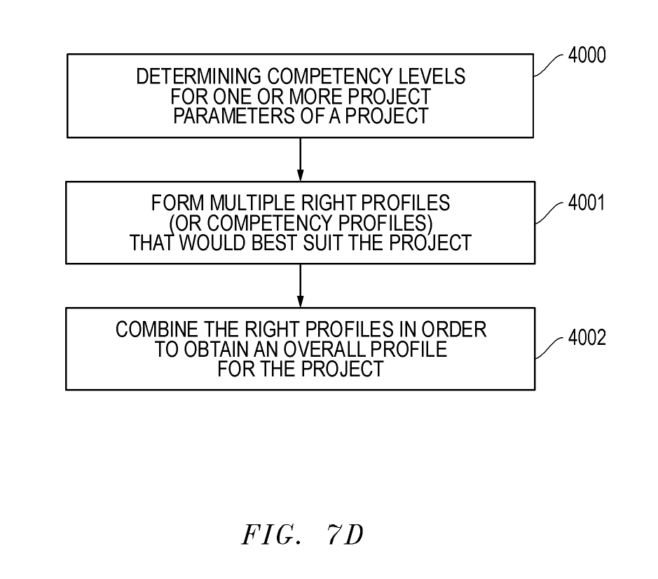

For example, FIG. 7A shows a general example of a score of the project 204 against the FOS score card. In FIG. 7A, the score is shown in green 106, if the service is the main topic of the project 204, shown in yellow 108, if the service is marginally included in the project 204, and shown in red 110, if the service is not included in the project 204. A management approval workflow is implemented as an integral part of the scoring mechanism to make sure that the items are scored properly.

Advantageously, the scoring mechanism, or FOS matrix, can be used to manage competency and careers, so that group competency can be determined, the use of the self assessment form can be used to track employee skills development, the scoring mechanism, or FOS matrix, can be used to build an employee career roadmap starting from a current self-assessment score to the targeted career profile, and scoring mechanism, or FOS matrix, can be used to select a training program for an employee, wherein appropriate training programs can be easily identified using an employee's score against the FOS. For example, FIG. 7B illustrates a process for providing group competency. In FIG. 7B, when building a group, location or project, one or more of the right profiles 402-406 can be combined to build a suitable overall profile 408, or at least to determine what is required for a given region or project. FIG. 7D illustrates a flowchart for the process for providing group competency by the framework of service unit 10. The flowchart begins at 4000 where competency levels for one or more project parameters of a project are determined. The flowchart continues at block 4001 wherein multiple right profiles (or competency profiles) are formed that would best suit the project. The flow continues at block 4002 wherein the right profiles are combined in order to obtain an overall profile for the project.

The scoring mechanism also allows the company to execute projects efficiently through easy selection of the project teams that match the project skills requirements, efficient and targeted search of best practices that relate to any one or a suitable combination of the many FOS services items, and through quick determination of the past projects, and which knowledge can be used for the current project. For example, FIG. 7C illustrates a process for providing team competency. In FIG. 7C, when building a team 410, the competence database is used to build the team 410 that can handle the different services 412 of the project 204.

The scoring mechanism also allows the company to support marketing and sales activities, including using a project bid FOS, formed by the FOS unit 10, to demonstrate to customers the business skills, capabilities and project experience in the service areas required by a customer bid document, looking at projects and bid FOSs to determine the area of focus of future business offerings, and to select teams for projects and reuse proposals from past or similar projects.

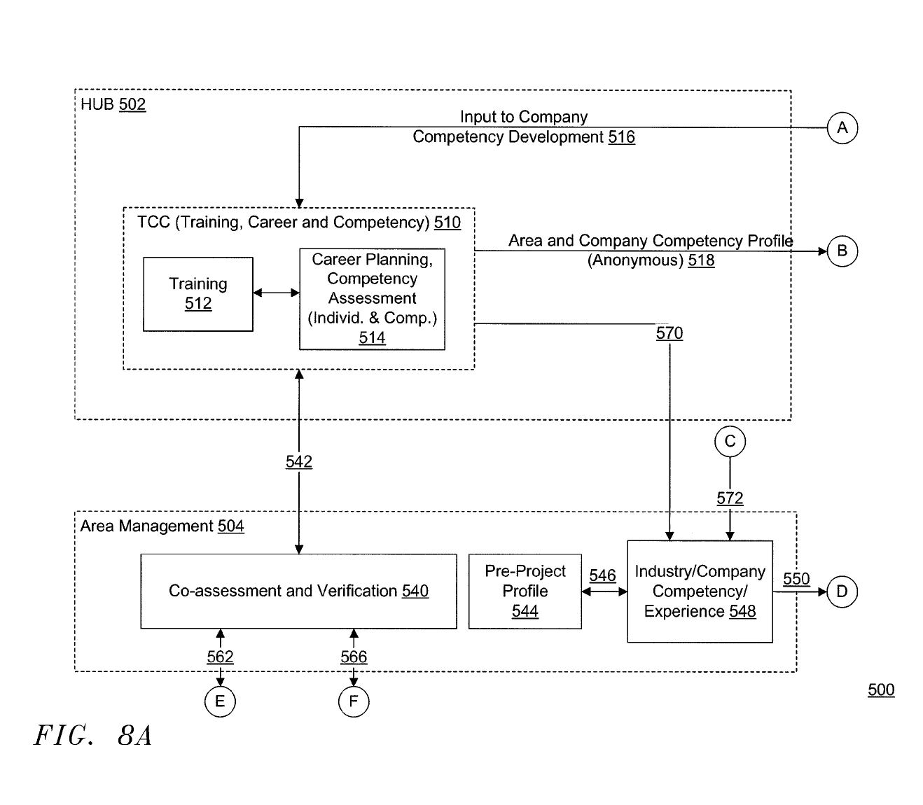

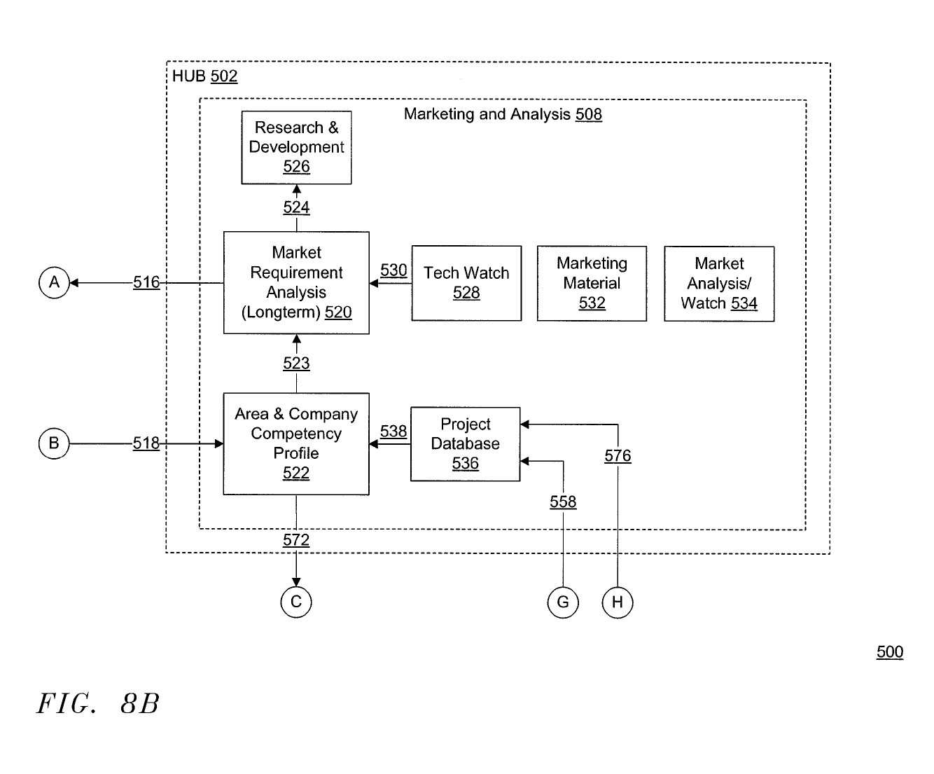

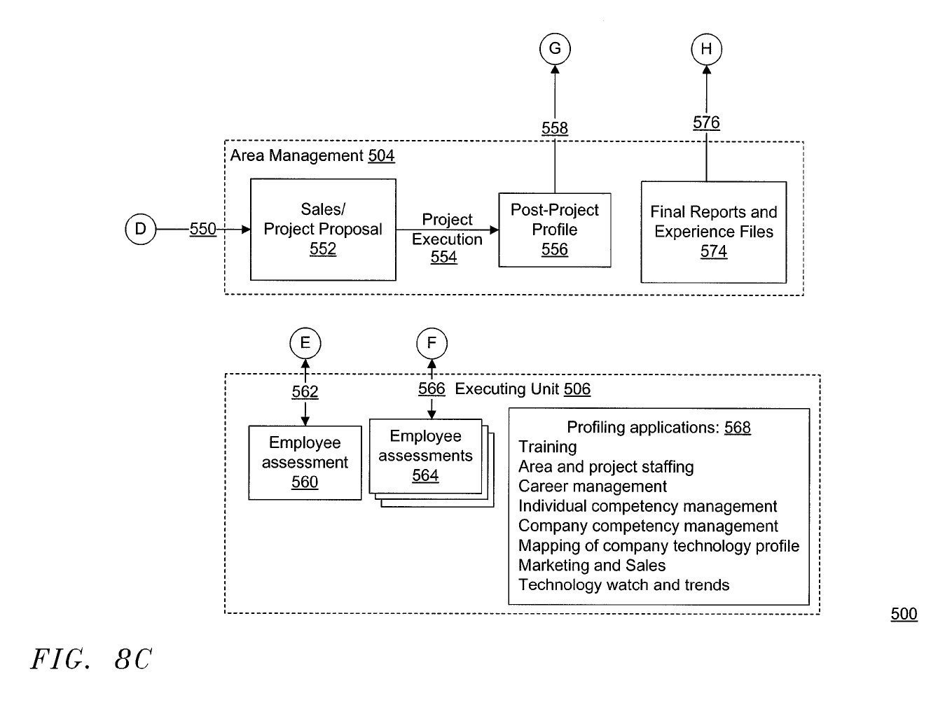

FIGS. 8A-8C illustrate an exemplary knowledge, oilfield management system 500 based on the exemplary embodiments of the present disclosure. In FIGS. 8A-8C, the exemplary system 500 includes a hub unit 502, an area management unit 504, and an executing unit 506. The hub unit 502 includes a marketing and analysis device 508 and a training and career competency (TCC) device 510. Any of the units shown in FIGS. 8A-8C may incorporate the framework of services unit 10 (as shown in FIGS. 1-3) and/or portions of the FOS unit 10. The TCC device 510 comprises a training device 512 and a career planning and competency assessment device 514. The TCC device 510 receives input information 516 for competency development from the marketing and analysis device 508 and outputs area and company competency profile information 518 to the marketing and analysis device 508. The TCC device 510 may comprise the functionality described for the training and career unit 32 (as shown on FIG. 3). The marketing and analysis device 508 may comprise functionality described for the marketing and analysis unit 34.

The marketing and analysis device 508 includes a market requirement analysis device 520 for generating the input information 516 and generating information 524 for a research and development device 526. The marketing and analysis device 508 also includes an area and company competency profile device 522 for receiving the profile information 518 and generating profile information 523 for the market requirement analysis device 520. The marketing and analysis device 508 also includes a technical watch device 528 for providing technical information 530 to the market requirement analysis device 520. The marketing and analysis device 508 also includes a marketing material device 532, a market analysis/watch device 534, and a project database 536, which provide project information 538 to the area and company competency profile device 522.

The area management unit 504 includes a co-assessment and verification device 540 for sending and receiving information 542 to/from the TCC device 510. The area management unit 504 also includes a pre-project profile device 544 for sending and receiving information 546 to/from an industry, company competency and experience device 548. The pre-project profile device 544 may comprise functionality described for the project execution unit 33. The industry, company competency and experience device 548 sends information 550 to a sales and project proposal device 552, receives information 570 from the TCC device 510 and information 572 from the area and company competency profile device 522. The sales and project proposal device 552 sends project execution information 554 to a post-project profile device 556, which sends information 558 to the project database 536. A final reports and experience files device 574 also sends information 576 to the project database 536

The executing unit 506 includes an employee assessment device 560 that sends and receives employee assessment information 562 to/from the co-assessment and verification device 540. The executing unit 506 may comprise functionality described for the matrix execution unit 35. The executing unit 506 also includes an employee assessments device 564 that sends and receives employee assessments information 566 to/from the co-assessment and verification device 540. The executing unit 506 also includes profiling applications 568, based on the various devices and units of the exemplary knowledge, oilfield management system 500. The profiling applications 568, for example, can include training applications, area and project staffing applications, career management applications, individual competency management applications, company competency management applications, applications for mapping of the company technology profile, marketing and sales applications, and technology watch and trending applications, and the like.

Advantageously, the knowledge, oilfield management system 500 processes and workflows can be automated using any suitable application (e.g., starting with MICROSOFT SHAREPOINT™ application as a base along with suitable development code) and can be used to manage all suitable aspects of the company's business. The exemplary system 500 can build and expand company knowledge through a central database that stores approved documents, configuration files, templates, and the like. These files can be related to any part of the company business, such as personnel, marketing, service delivery, and the like. The exemplary system 500 can create an environment in which information is accessible to company consultants and in which individuals acquire, share and use (or reuse) that information to develop their own knowledge, increase their productivity and are encouraged and enabled to apply their knowledge for the benefit of the company business.

The system 500 enables an environment in which company consultants and business development managers can retrieve and self-upload a wealth of information, including personnel data, such as competency levels, resumes, career roadmaps, and training materials, marketing data, such as materials for developing new relationships with clients or engaging new services with existing clients, competition data, company marketing materials, client base, and past bids data, project delivery and technology data, such as a parameters database and configuration files (e.g., including binary files or executables), best practices, case studies, products and services, and generic documents and templates, and the like.

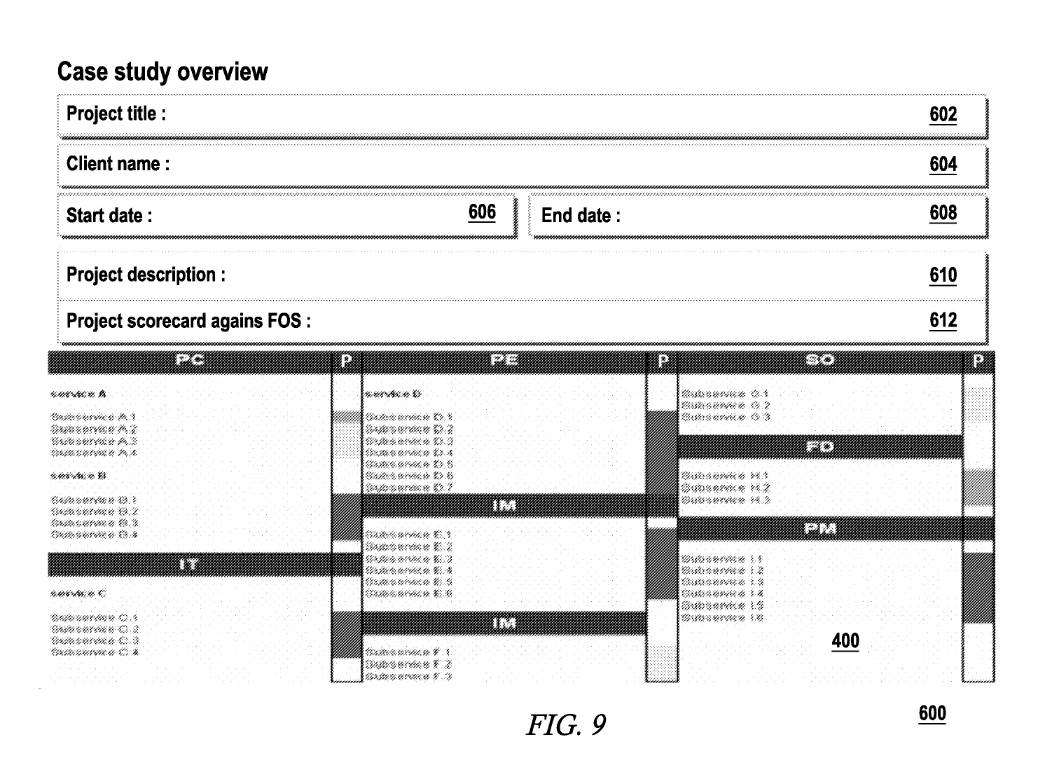

Content management processes may include, for example, the system 500 implementing an approval process that is driven by an uploading and approval governance process. The contents can be organized such that the information can be easily found by anyone in the organization. The format of each page can have the same look and format. In order to achieve that objective, each entry can be scored against its relevance to the FOS services. For example, FIG. 7A shows an example of the score of an item against the FOS score card, as previously described. Typically, when a user clicks on an entry, the first item they see is the score card of the entry. Each entry can include a summary sheet based on provided summary sheet templates. FIG. 9 shows an example summary sheet 600 for a case study entry. Each entry can have output or supporting documents for the entry. In FIG. 9, the summary sheet 600 includes project title field 602, client name field 604, start date field 606, end date field 608, project description field 610, and project score card against FOS field 612 for displaying the project score card against FOS 400.

The system 500 can include multi-level security, including, for example, 4 levels of access security from a lowest to a highest security level. A Client security level includes information that the company will expose to clients, a Company Public security level includes information that can be accessed by any company employee, a Public security level includes information that can be accessed by designated individuals of the parent business of the company, and a Private security level includes information that only a company individual can access, depending on their security credentials.

The system 500 provides usage and monitoring statistics. For example, in order to assess the degree of success and adoption by users of the oilfield management, the system 500 can track the usage and convert it to key performance indicators (KPI). The KPIs can be tracked, for example, on a monthly basis to evaluate the success of the system 500 and develop strategies to improve its usage.

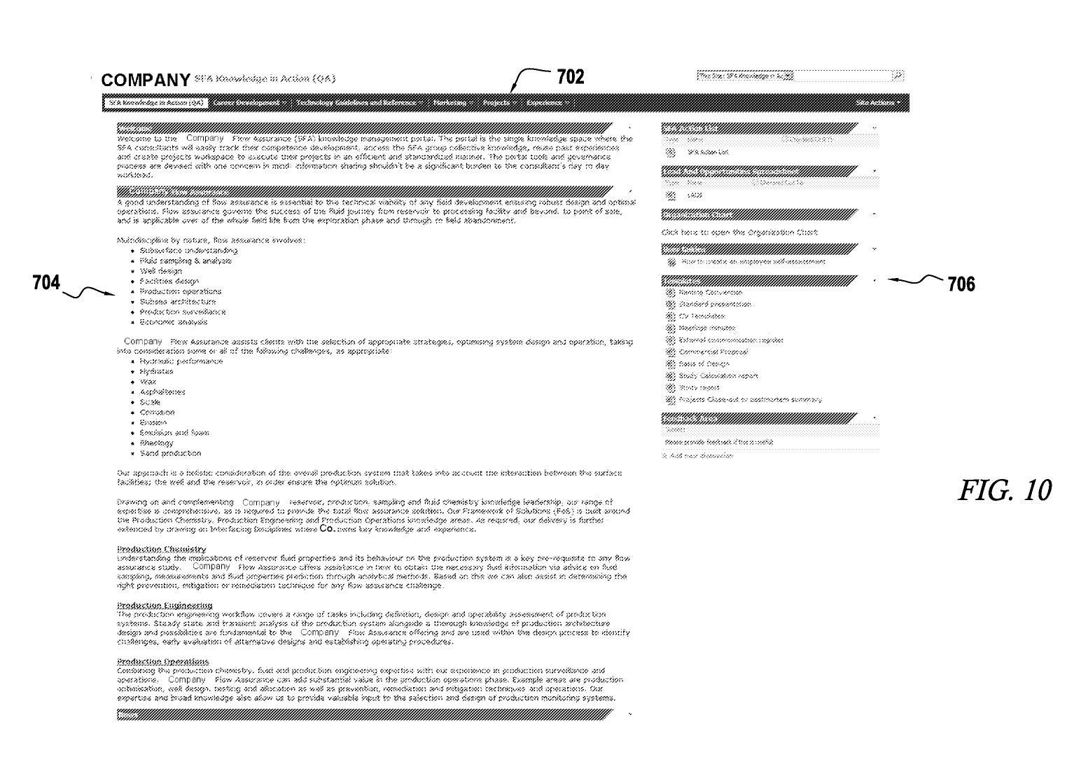

FIGS. 10-19 illustrate screenshots of an exemplary web site corresponding to the knowledge management, or oilfield management system 500 of FIGS. 8A-8C. For example, FIG. 10 illustrates an exemplary start or home page 700. In FIG. 10, the start or home page 700 includes drop down menus 702, a text and web link display area 704, and a document download area 706.

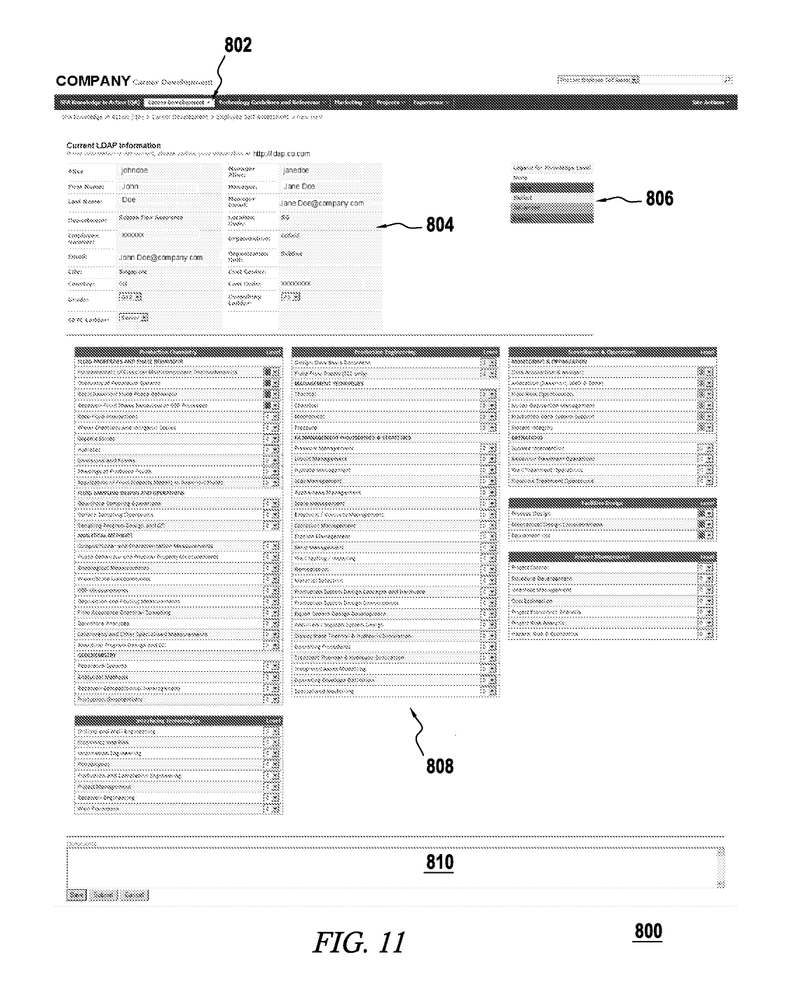

FIG. 11 illustrates an exemplary employee self-assessment page 800, for example, based on FIG. 6. In FIG. 11, the employee self-assessment page 800 is part of a career development drop down menu 802, and includes an employee information area 804, a legend 806 for color coded knowledge levels, an area 808 for self-assessment of engineering skills, and a comments area 810.

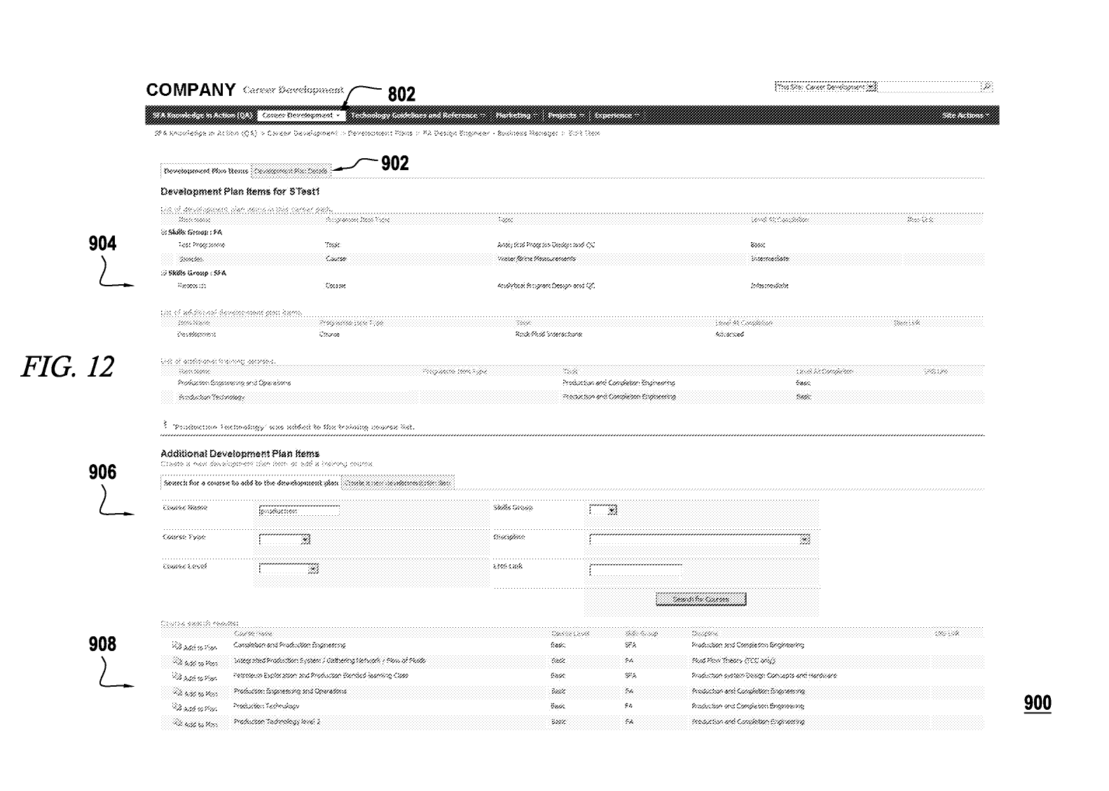

FIG. 12 illustrates an exemplary career development plan page 900. In FIG. 12, the career development plan page 900 is part of the career development drop down menu 802, and includes development plan items and details tabs 902, development plan items display area 904, a search area 906 for searching for items to add to the development plan, and a search results area 908 for listing/adding items from search results.

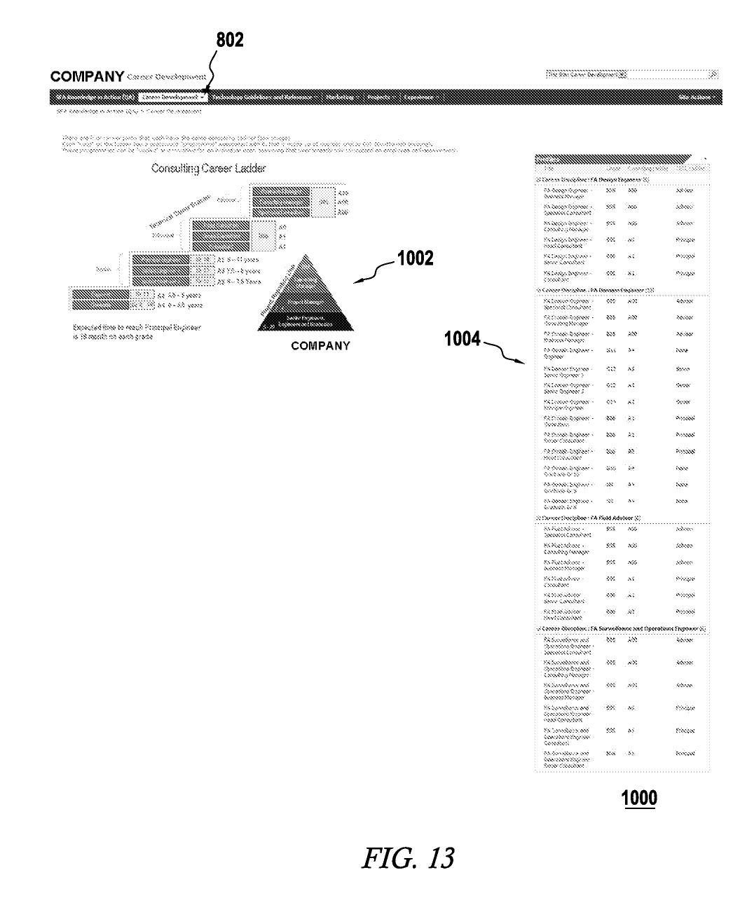

FIG. 13 illustrates an exemplary career paths page 1000. In FIG. 13, the career paths page 1000 is part of the career development drop down menu 802, and includes career paths details 1002, and career path profiles 1004.

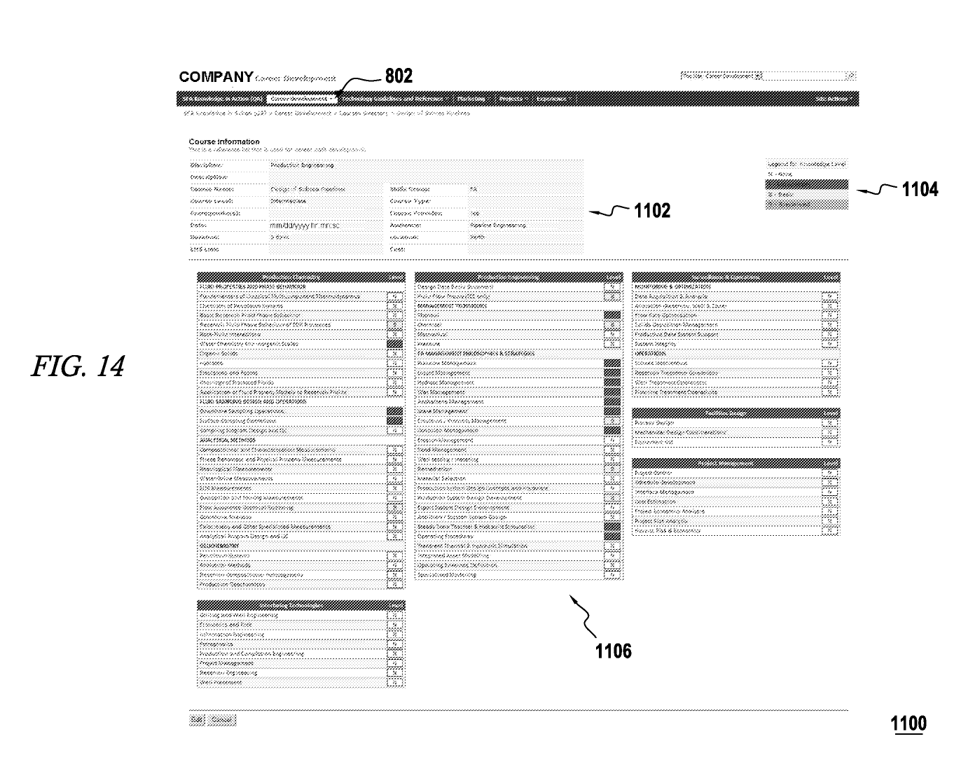

FIG. 14 illustrates an exemplary training course page 1100. In FIG. 14, the training course page 1100 is part of the career development drop down menu 802, and includes course information 1102, a legend 1104 for knowledge levels, and an area 1106 for showing engineering disciplines versus knowledge levels.

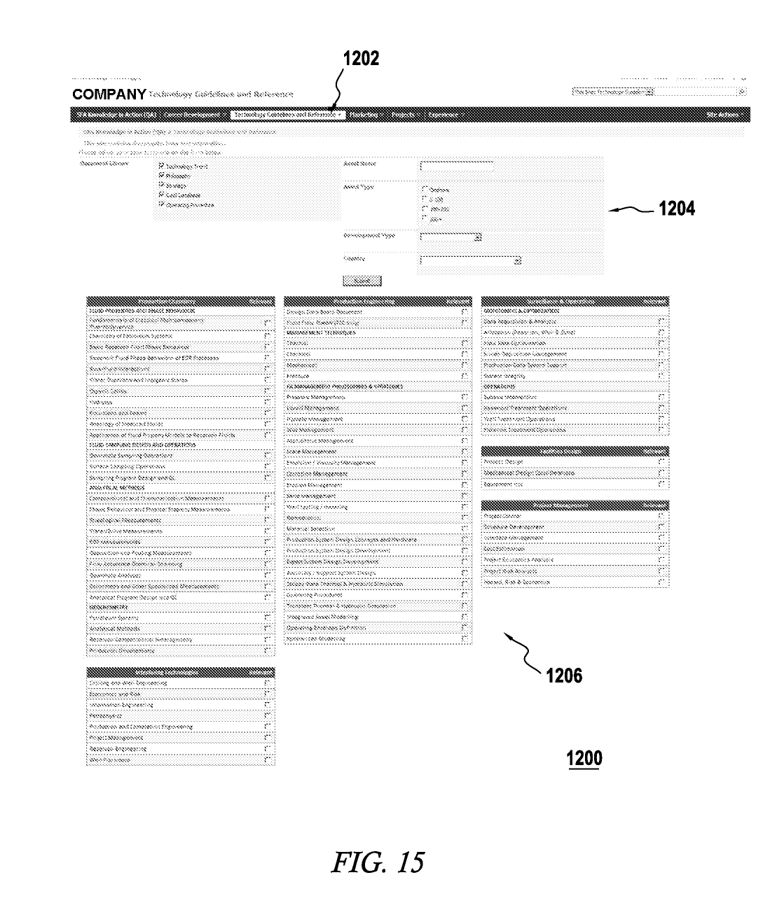

FIG. 15 illustrates an exemplary technology guidelines and reference search page 1200. In FIG. 15, the technology guidelines and reference search page 1200 is part of a technology guidelines and reference drop down menu 1202, and includes a search criteria area 1204 for entering search criteria, and an engineering disciplines area 1206 for entering engineering disciplines related to the search.

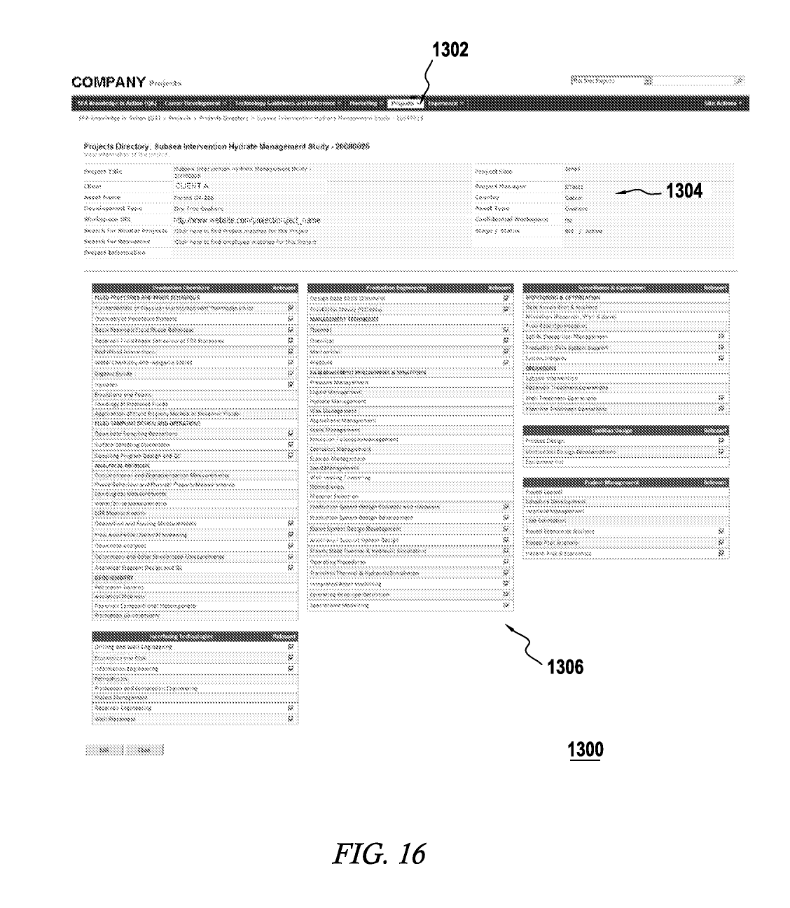

FIG. 16 illustrates an exemplary projects directory page 1300, for example, based on FIG. 2. In FIG. 16, the projects directory page 1300 is part of a projects drop down menu 1302, and includes a project information area 1304, and an engineering disciplines area 1306 for entering engineering disciplines related to the project.

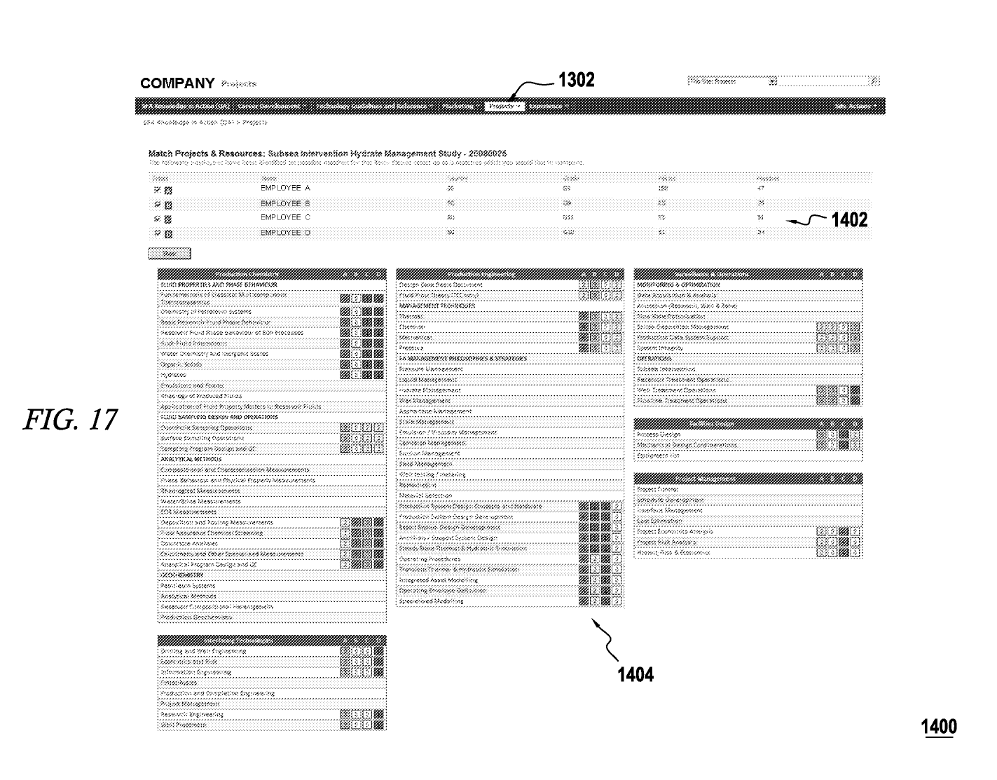

FIG. 17 illustrates an exemplary project versus resources page 1400, for example, based on FIG. 4C. In FIG. 17, the project versus resources page 1400 is part of the projects drop down menu 1302, and includes an area 1402 showing employees that may match up with project requirements, and an engineering disciplines area 1404 for showing engineering disciplines and experience levels for the employees.

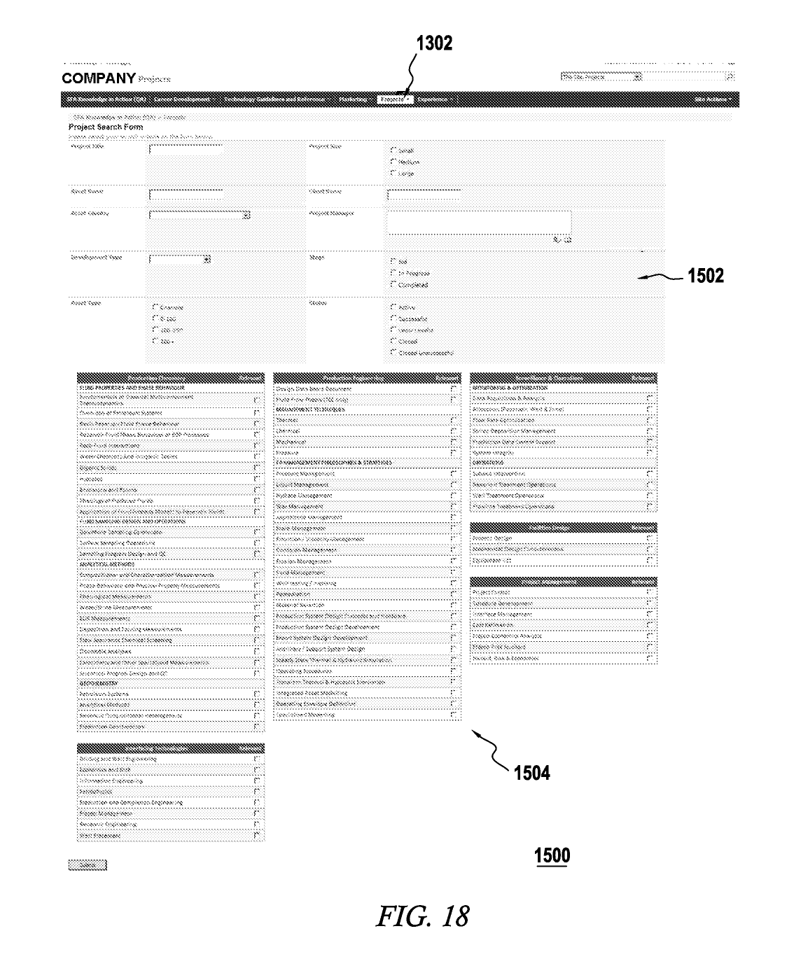

FIG. 18 illustrates an exemplary project search page 1500. In FIG. 18, the project search page 1500 is part of the projects drop down menu 1302, and includes a search criteria area 1502, and an engineering disciplines area 1504 for entering engineering disciplines for the search.

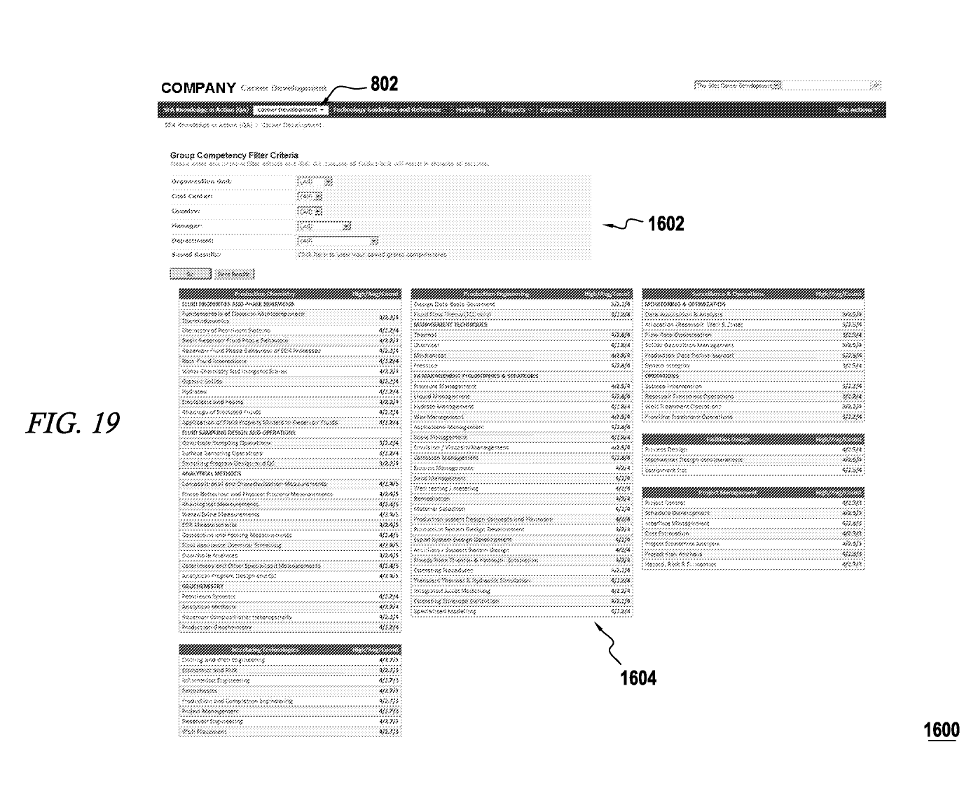

FIG. 19 illustrates a method 2010 for performing an oilfield operation involving an exemplary group competency page 1600. In FIG. 19, the group competency page 1600 is part of the career development drop down menu 802, and includes a group competency filter criteria area 1602, and an engineering disciplines results area 1604 for displaying the group competency for the engineering disciplines for the search.

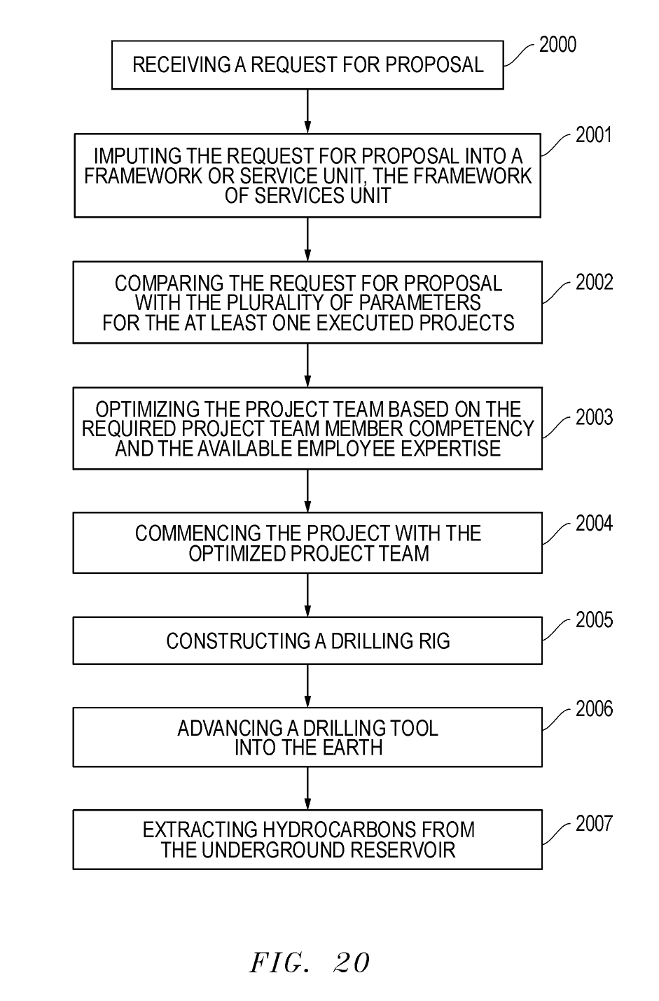

FIG. 20 depicts a flowchart illustrating the optimizing of a potential project. The potential project may be any project but will be described as a project for extracting hydrocarbons from an underground reservoir. The flow begins at block 2000 wherein a request for proposal is received. The flow continues at block 2001 wherein the request for proposal is input into a framework of service unit. The flow continues at block 2002 wherein the request for proposal is compared with the plurality of parameters for at least one executed project. The flow continues at block 2003 wherein the project team is optimized based on the required project team member competency and the available employee expertise. The flow continues at block 2004 wherein the project is commenced with the optimized project team. The flow continues at block 2005 wherein a drilling rig is constructed using the optimized project team. The flow continues at block 2006 wherein a drilling tool is advanced into the earth. The flow continues at block 2007 wherein the hydrocarbons are extracted from the underground reservoir.

The present disclosure includes recognition that with the trends in the market today, including clients increasingly concerned about competency and experience of consulting companies' staff, contract awards are increasingly based solely on documented competence and experience and not competitive bidding. Advantageously, the system 500 provides a key tool for managing various aspects of consulting, including career management, recruiting and retaining, competency management, training, knowledge management, or oilfield management, web site (internal and external), experience and knowledge transfer, technology watch and trends, capturing business opportunities, business development and marketing, and project profiling and staffing. The project profiling aligned with personnel profiling provided by the system 500 are important instruments and differentiators in the project award process.

The above-described systems, units and devices of the exemplary embodiments can be accessed by or included in, for example, any suitable clients, workstations, PCs, laptop computers, PDAs, Internet appliances, handheld devices, cellular telephones, wireless devices, other devices, and the like, capable of accessing or employing the new architecture of the exemplary embodiments. The systems, units and devices of the exemplary embodiments can communicate with each other using any suitable protocol and can be implemented using one or more programmed computer systems or devices.

One or more interface mechanisms can be used with the exemplary embodiments, including, for example, Internet access, telecommunications in any suitable form (e.g., voice, modem, and the like), wireless communications media, and the like. For example, employed communications networks or links can include one or more wireless communications networks, cellular communications networks, cable communications networks, satellite communications networks, G3 communications networks, Public Switched Telephone Network (PSTNs), Packet Data Networks (PDNs), the Internet, intranets, WiMax Networks, a combination thereof, and the like.

It is to be understood that the systems, units and devices of the exemplary embodiments are for exemplary purposes, as many variations of the specific hardware used to implement the exemplary embodiments are possible, as will be appreciated by those skilled in the relevant art(s). For example, the functionality of one or more of the systems, units and devices of the exemplary embodiments can be implemented via one or more programmed computer systems or devices.

To implement such variations as well as other variations, a single computer system can be programmed to perform the special purpose functions of one or more of the systems, units and devices of the exemplary embodiments. On the other hand, two or more programmed computer systems or devices can be substituted for any one of the systems, units and devices of the exemplary embodiments. Accordingly, principles and advantages of distributed processing, such as redundancy, replication, and the like, also can be implemented, as desired, to increase the robustness and performance of the systems, units and devices of the exemplary embodiments.

The systems, units and devices of the exemplary embodiments can store information relating to various processes described herein. This information can be stored in one or more memories, such as a hard disk, optical disk, magneto-optical disk, RAM, and the like, of the systems, units and devices of the exemplary embodiments. One or more databases of the systems, units and devices of the exemplary embodiments can store the information used to implement the exemplary embodiments of the present disclosure. The databases can be organized using data structures (e.g., records, tables, arrays, fields, graphs, trees, lists, and the like) included in one or more memories or storage devices listed herein. The processes described with respect to the exemplary embodiments can include appropriate data structures for storing data collected and/or generated by the processes of the systems, units and devices of the exemplary embodiments in one or more databases thereof.

All or a portion of the systems, units and devices of the exemplary embodiments can be conveniently implemented using one or more general purpose computer systems, microprocessors, digital signal processors, micro-controllers, and the like, programmed according to the teachings of the exemplary embodiments of the present disclosure, as will be appreciated by those skilled in the computer and software arts. Appropriate software can be readily prepared by programmers of ordinary skill based on the teachings of the exemplary embodiments, as will be appreciated by those skilled in the software art. Further, the systems, units and devices of the exemplary embodiments can be implemented on the World Wide Web. In addition, the systems, units and devices of the exemplary embodiments can be implemented by the preparation of application-specific integrated circuits or by interconnecting an appropriate network of conventional component circuits, as will be appreciated by those skilled in the electrical art(s). Thus, the exemplary embodiments are not limited to any specific combination of hardware circuitry and/or software.

Stored on any one or on a combination of computer readable media, the exemplary embodiments of the present disclosure can include software for controlling the systems, units and devices of the exemplary embodiments, for driving the systems, units and devices of the exemplary embodiments, for enabling the systems, units and devices of the exemplary embodiments to interact with a human user, and the like. Such software can include, but is not limited to, device drivers, firmware, operating systems, development tools, applications software, and the like. Such computer readable media further can include the computer program product of an embodiment of the present disclosure for performing all or a portion (if processing is distributed) of the processing performed in implementing the present disclosure. Computer code devices of the exemplary embodiments of the present disclosure can include any suitable interpretable or executable code mechanism, including but not limited to scripts, interpretable programs, dynamic link libraries (DLLs), Java classes and applets, complete executable programs, Common Object Request Broker Architecture (CORBA) objects, and the like. Moreover, parts of the processing of the exemplary embodiments of the present disclosure can be distributed for better performance, reliability, cost, and the like.

As stated above, the systems, units and devices of the exemplary embodiments can include computer readable medium or memories for holding instructions programmed according to the teachings of the present disclosure and for holding data structures, tables, records, and/or other data described herein. Computer readable medium can include any suitable medium that participates in providing instructions to a processor for execution. Such a medium can take many forms, including but not limited to, non-volatile media, volatile media, transmission media, and the like. Non-volatile media can include, for example, optical or magnetic disks, magneto-optical disks, and the like. Volatile media can include dynamic memories, and the like. Transmission media can include coaxial cables, copper wire, fiber optics, and the like. Transmission media also can take the form of acoustic, optical, electromagnetic waves, and the like, such as those generated during radio frequency (RF) communications, infrared (IR) data communications, and the like. Common forms of computer-readable media can include, for example, a floppy disk, a flexible disk, hard disk, magnetic tape, any other suitable magnetic medium, a CD-ROM, CDRW, DVD, any other suitable optical medium, punch cards, paper tape, optical mark sheets, any other suitable physical medium with patterns of holes or other optically recognizable indicia, a RAM, a PROM, an EPROM, a FLASH-EPROM, any other suitable memory chip or cartridge, a carrier wave or any other suitable medium from which a computer can read.

Although the present disclosure has been described with reference to exemplary embodiments and implementations thereof, the present disclosure is not to be limited by or to such exemplary embodiments and/or implementations. Rather, the systems and methods of the present disclosure are susceptible to various modifications, variations and/or enhancements without departing from the spirit or scope of the present disclosure. Accordingly, the present disclosure expressly encompasses all such modifications, variations and enhancements within its scope.

While the embodiments are described with reference to various implementations and exploitations, it will be understood that these embodiments are illustrative and that the scope of the inventive subject matter is not limited to them. Many variations, modifications, additions and improvements are possible. For example, additional sources and/or receivers may be located about the wellbore to perform seismic operations.

Plural instances may be provided for components, operations or structures described herein as a single instance. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

What is claimed is:

1. A system for executing an oilfield operation at a wellsite, wherein the oilfield operation is a potential project, comprising:
a project execution unit configured to quantify a plurality of project parameters of at least one executed project, wherein a first project parameter is a success rate of the at least one executed projects, and a second project parameter is a required project team member competency for the at least one executed projects;
an employee assessment unit configured to assess a level of expertise obtained by each of a plurality of employees for a plurality of skill sets; and
a matrix execution unit configured to compare to the required project team member competency to the level of expertise of each of the plurality of employees in each of the plurality of skill sets in order to select a group of employees to be used to complete the project team.

2. The system of claim 1, further comprising a training and career unit configured to determine one or more career paths of each of the plurality of employees.

3. The system of claim 2, wherein the training and career unit may be configured to evaluate a plurality of training available for the plurality of employees.

4. The system of claim 3, wherein the matrix execution unit is configured to choose one of the plurality of training for at least one of the plurality of employees based on the career path selected for the at least one employee.

5. The system of claim 1, further comprising a market and analysis unit configured to assess the potential project based on the plurality of project parameters in order to customize a proposal for the client.

6. The system of claim 5, wherein the marketing and analysis unit is further configured to customize the proposal by selecting one or more of the plurality of employees to fill the project team.

7. The system of claim 1, wherein the project comprises a hydrocarbon recovery project and the system further includes a service company for executing the potential project, a communication network, and a selected project team configure to construct a rig for recovering hydrocarbons.

8. A method for executing an oilfield operation at a wellsite, wherein the oilfield operation is a potential project, comprising:
receiving a request for proposal;
imputing the request for proposal into a framework of service unit, the framework of services unit comprising:
a project execution unit configured to quantify a plurality of project parameters of at least one executed project, wherein a first project parameter is a success rate of the at least one executed projects, and a second project parameter is a required project team member competency for the at least one executed projects;
an employee assessment unit configured to assess a level of expertise obtained by each of a plurality of employees for a plurality of skill sets; and
a matrix execution unit configured to compare to the required project team member competency to the level of expertise of each of the plurality of employees in each of the plurality of skill sets in order to select a group of employees to be used to complete the project team;
comparing the request for proposal with the plurality of project parameters for the at least one executed projects;
compiling a proposed project execution plan based on the compared request for proposal; and
assembling a bid proposal comprising the proposed project execution plan.

9. The method of claim 8, wherein compiling the proposed project execution plan further comprises optimizing the project team by matching the required project team member competency with the group of employees to be used to complete the project team.

10. The method of claim 8, further comprising assessing the employee expertise based on a scaled method.

11. The method of claim 10, further comprising quantifying past project success based on the scaled method.

12. The method of claim 11, wherein executing the potential project further comprises extracting hydrocarbons from an underground reservoir.

13. A method for optimizing a potential project for extracting hydrocarbons from an underground reservoir, the method comprising:
receiving a request for proposal;
imputing the request for proposal into a framework of service unit, the framework of services unit comprising:
a project execution unit configured to quantify a plurality of project parameters of at least one executed project, wherein
a first project parameter is a success rate of the at least one executed projects, and a second project parameter is a required project team member competency for the at least one executed projects;
an employee assessment unit configured to assess a level of expertise obtained by each of a plurality of employees for a plurality of skill sets; and
a matrix execution unit configured to compare to the required project team member competency to the level of expertise of each of the plurality of employees in each of the plurality of skill sets in order to select a group of employees to be used to complete the project team;
comparing the request for proposal with the plurality of parameters for the at least one executed projects;
optimizing the project team by matching the required project team member competency with a group of available employees having a required expertise;
commencing the project with the optimized project team;
constructing a drilling rig;
advancing a drilling tool into the earth; and
extracting hydrocarbons from the underground reservoir.

14. The method of claim 13, further comprising assessing the employee expertise based on a scaled method.

15. The method of claim 14, further comprising quantifying past project success based on the scaled method.

16. The method of claim 13, further comprising training the employees to meet the requirements of the optimized project team.

17. The method of claim 16, further comprising selecting training for the employee based on a selected career path for the employee.
